(19) United States
(12) Patent Application Publication
(10) Pub. No.: US 2025/0196420 A1
(43) Pub. Date: Jun. 19, 2025

(54) MULTILAYER CRYSTALLIZABLE SHRINKABLE FILM AND SHEET

(71) Applicant: Eastman Chemical Company, Kingsport, TN (US)

(72) Inventors: James Carl Williams, Blountville, TN (US); Mark Allen Peters, Telford, TN (US); Huamin Hu, Johnson City, TN (US); Michael Keith Coggins, Jonesborough, TN (US); Thomas James Pencarinha, Kingsport, TN (US)

(73) Assignee: Eastman Chemical Company, Kingsport, TN (US)

(21) Appl. No.: 18/847,983

(22) PCT Filed: Mar. 16, 2023
(86) PCT No.: PCT/US2023/064501

§ 371 Date: Sep. 17, 2024

Related U.S. Application Data
(60) Provisional application No. 63/269,574, filed on Mar. 18, 2022.

(51) Int. Cl. B29C 48/21; B29C 48/00; B29C 48/08; B29C 71/02; B29K 67/00; B29K 105/00; B29K 105/26; B29L 7/00; B29L 9/00

(52) U.S. Cl. CPC B29C 48/21; B29C 48/0018; B29C 48/022; B29C 48/08; B29C 71/02; B29C 2071/022; B29C 2948/92704; B29C 2948/92961; B29K 2067/04; B29K 2105/0088; B29K 2105/0094; B29K 2105/26; B29K 2995/0049; B29K 2995/0051; B29L 2007/008; B29L 2009/00

(57) ABSTRACT

Multilayer crystallizable heat shrinkable films and sheets comprising amorphous copolyester compositions and crystallizable copolyester compositions which comprise residues of terephthalic acid, neopentyl glycol (NPG), 1,4-cyclohexanedimethanol (CHDM), ethylene glycol (EG), and diethylene glycol (DEG), and which incorporate recycled PET, in certain compositional ranges having certain advantages and improved properties including recyclability.

### FIELD OF THE INVENTION

The present disclosure relates to multilayer crystallizable shrinkable films and/or sheet(s) comprising amorphous copolyester compositions and crystallizable copolyester composition which comprise residues of terephthalic acid, neopentyl glycol (NPG), 1,4-cyclohexanedimethanol (CHDM), ethylene glycol (EG), diethylene glycol (DEG) and which incorporate recycled PET, in certain compositional ranges having certain advantages and improved properties including recyclability.

### BACKGROUND OF THE INVENTION

There is a commercial need for multilayer shrink films that have at least one of the following desirable shrink film properties: (1) low onset shrinkage temperature, (2) a shrinkage percentage which increases gradually and in a controlled manner with increasing temperature over the temperature range where shrinkage occurs, (3) a shrink force low enough to prevent crushing of the underlying container, (4) a high ultimate shrinkage (shrinkage at the highest temperature), e.g. 50% or greater shrinkage in the main shrinkage direction at 95° C., (5) low shrinkage in the direction orthogonal to the high shrinkage direction, (6) improved film toughness so as to prevent unnecessary fracturing, breaking, tearing, splitting, bubbling, or wrinkling of the film during manufacture and prior to and after shrinkage, (6) made from recycle content and (7) recyclability.

### BRIEF SUMMARY OF THE INVENTION

It has been found that certain combinations of glycol monomers in a shrink film resin composition can produce a multilayer film with good shrink film performance and also be crystallizable such that it does not negatively impact the recycling of the PET flake during recycling. These multilayer crystallizable shrink films can be processed with the PET bottle and end up as a component in the recyclable PET flake leaving the recycling process. It has also been found that the choice and quantity of specific combinations of glycol monomers are important to produce multilayer films with good shrink film properties and to produce a multilayer film that is crystallizable. The optimized polyester resin compositions and blends of this disclosure are amorphous but crystallizable. As such, they exhibit good properties in film applications including as shrink films, but they have high strain induced crystalline melting points, so they provide compatibility in recycling processes. The multilayer shrink film labels of the present disclosure do not have to be removed during the recycle process, and they do not impact the process.

Historically, some crystallizable films may present processing challenges. In some instances, crystallizable films may exhibit high on-set shrink temperatures and a high shrink rate. Because of these features, the crystallizable films are often not compatible in some applications; for example, with labelling HDPE containers in a hot air tunnel. The high onset shrinkage temperature does not allow the crystallizable films to shrink prior to expansion of the HDPE container and after the bottle leaves the shrink tunnel, the label is likely to be loose. Additionally, the high shrink rate will often create wrinkles during the shrink process in a hot air tunnel.

In other instances, crystallizable films may have a high shrink rate. So, if they are used in applications as a container label, the high shrink rate can cause wrinkles in the film as well as distort the container's shape depending on its design, especially in applications with thin bottles or bottles with poor modulus. The multilayer crystallizable films of the present disclosure provide a solution for these processing challenges of high on-set shrink temperatures and high shrink rate.

The multilayer crystallizable films of the present disclosure also address some of the sustainability concerns and requirements for the incorporation of recycled content into heat shrinkable films. Recycled PET (rPET) is incorporated directly into the multilayer crystallizable films of the present disclosure. Historically, films containing a large amount of rPET material tend to have inferior film properties when compared to films without any rPET. However, in the present disclosure, the optimized blend ratios and multilayer configurations provide the benefits of both the inclusion of rPET and the inclusion of the crystallizable resins. The multilayer crystallizable films of the present disclosure have improved shrink characteristics even with the inclusion of rPET and they are also compatible with the PET recycle stream.

Moreover, the multilayer crystallizable films of the present disclose affords the additional advantages, for instance of lower shrink force and the incorporation of rPET without affecting other properties.

The multilayer films must meet a variety of fitness for use criteria to perform in this application. The multilayer films must be tough, must shrink in a controlled manner, and must provide enough shrink force to hold itself on the bottle without crushing the contents. In addition, when these labels are applied to polyester containers, the multilayer polyester shrink film labels must not interfere with the recycling process of the bottle. The multilayer shrink films of the present disclosure are advantageous because the label can be recycled with the bottle or container. As such, the entire bottle, including the label, can be recycled and converted into new products without creating additional handling requirements or creating new environmental issues. Thermoshrinkable films have been made from a variety of raw materials to meet a range of material demands. This disclosure describes unique and unexpected effects measured with certain monomers combinations for shrink film resin compositions.

Polyester shrink film compositions have been used commercially as shrink film labels for food, beverage, personal care, household goods, etc. Often, these shrink films are used in combination with a clear polyethylene terephthalate (PET) bottle or container. The total package (bottle plus label) is then placed in the recycling process. In a typical recycling center, the PET and the shrink film material often end up together at the end of the process due to similarities in composition and density. Drying of the PET flake is required to remove residual water that remains with the PET through the recycling process. Typically, PET is dried at temperatures above 150° C., and in some instances above 200° C. At those temperatures, typical polyester shrink film resins will soften and become sticky, often creating clumps with PET flakes. These clumps must be removed before further processing. These clumps reduce the yield of PET flake from the process and create an additional handling step.

Also, it has been found that certain combinations of glycol monomers in a film or sheet resin composition can produce film or sheet with good performance properties and is also crystallizable such that it does not impact the recycling of the PET flake. These crystallizable film or sheet resins can be processed with recycled PET and end up as a component in the recyclable PET flake leaving the recycling process. It has also been found that the choice and quantity of specific combinations of glycol monomers are important to produce films or sheet with good performance properties and to produce a film or sheet that is crystallizable. The optimized polyester resin compositions of this disclosure are amorphous but crystallizable. As such, they exhibit good properties in film or sheet applications including as molded, thermoformed, or shaped parts and/or articles, but they have high strain induced crystalline melting points, so they can be recycled with PET. The films or sheet of the present disclosure do not have to be removed during the recycle process, and they do not impact the recycle process.

One embodiment of the present disclosure is a multilayer crystallizable film comprising at least one skin layer (A) which comprises a polyester composition comprising: at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
   (i) about 0 to less than about 24 mole % of neopentyl glycol residues;
   (ii) 0 to less than about 24 mole % of 1,4-cyclohexanedimethanol residues;
   (iii) about 1 to less than about 15 mole % of total diethylene glycol residues and/or butanediol residues in the final polyester composition;
wherein the total mole % of the dicarboxylic acid component is 100 mole %, and wherein the total mole % of the diol component is 100 mole %; and
at least one core layer (B) which comprises a blend of 30-95 wt % of at least one polyester composition comprising:
at least one polyester which comprises:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
   (i) 15 mole % to less than about 30 mole % of 1,4-cyclohexanedimethanol residues;
   (ii) about 7 mole % to less than about 15 mole % of total diethylene glycol residues and/or butanediol residues in the final polyester composition;
wherein the total mole % of the dicarboxylic acid component is 100 mole %, and wherein the total mole % of the diol component is 100 mole %; and 5-70 wt % at least one at least one polyester composition comprising:
at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 50 mole % or greater of ethylene glycol residues and
about 50 mole % or less of other glycols comprising one or more of:
   (i) 0 mole % to less than about 50 mole % of 1,4-cyclohexanedimethanol residues;
   (ii) about 0.1 mole % to less than about 15 mole % of total diethylene glycol residues and/or butanediol residues in the final polyester composition;
wherein the total mole % of the dicarboxylic acid component is 100 mole %, and wherein the total mole % of the diol component is 100 mole %.

One embodiment of the present disclosure is a multilayer crystallizable film comprising at least one skin layer (A) which comprises a blend of 50-99.9 wt % at least one polyester composition (1) comprising: at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
   (i) about 0 to less than about 24 mole % of neopentyl glycol residues;
   (ii) 0 to less than about 24 mole % of 1,4-cyclohexanedimethanol residues;
   (iii) about 1 to less than about 15 mole % of total diethylene glycol residues and/or butanediol residues in the final polyester composition;
wherein the total mole % of the dicarboxylic acid component is 100 mole %, and wherein the total mole % of the diol component is 100 mole %; and 0.1-50 wt % of at least one polyester composition (2) comprising: at least one polyester which comprises:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
   (i) 15 mole % to less than 30 mole % of 1,4-cyclohexanedimethanol residues;
   (ii) 7 mole % to less than 15 mole % of total diethylene glycol residues and/or butanediol residues in the final polyester composition;
wherein the total mole % of the dicarboxylic acid component is 100 mole %, and wherein the total mole % of the diol component is 100 mole %; and
at least one core layer (B) which comprises a blend of 30-95 wt % of at least one polyester composition (1) comprising:
at least one polyester which comprises:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
   (i) 15 mole % to less than 30 mole % of 1,4-cyclohexanedimethanol residues;
   (ii) 7 mole % to less than 15 mole % of total diethylene glycol residues and/or butanediol residues in the final polyester composition;
wherein the total mole % of the dicarboxylic acid component is 100 mole %, and wherein the total mole % of the diol component is 100 mole %; and 5-70 wt % at least one at least one polyester composition (2) comprising:
at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 50 mole % or greater of ethylene glycol residues and
about 50 mole % or less of other glycols comprising one or more of:
   (i) 0 mole % to less than about 50 mole % of 1,4-cyclohexanedimethanol residues;
   (ii) about 0.1 mole % to less than about 15 mole % of total diethylene glycol residues and/or butanediol residues in the final polyester composition;
wherein the total mole % of the dicarboxylic acid component is 100 mole %, and wherein the total mole % of the diol component is 100 mole %.

One embodiment of the present disclosure is a multilayer crystallizable film comprising at least one skin layer (A) which comprises a blend of 50-99.9 wt % at least one polyester composition (1) comprising: at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
   (i) about 0 to less than about 24 mole % of neopentyl glycol residues;
   (ii) 0 to less than about 24 mole % of 1,4-cyclohexanedimethanol residues;
   (iii) about 1 to less than about 15 mole % of total diethylene glycol residues and/or butanediol residues in the final polyester composition;
wherein the total mole % of the dicarboxylic acid component is 100 mole %, and wherein the total mole % of the diol component is 100 mole %; and 0.1-50 wt % of at least one polyester composition (2) comprising:
at least one polyester which comprises:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
   (i) 15 mole % to less than 30 mole % of 1,4-cyclohexanedimethanol residues;
   (ii) 7 mole % to less than 15 mole % of total diethylene glycol residues and/or butanediol residues in the final polyester composition;
wherein the total mole % of the dicarboxylic acid component is 100 mole %, and wherein the total mole % of the diol component is 100 mole %; and
at least one core layer (B) which comprises a blend of 20-30 wt % of at least one polyester composition (1) comprising:
at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
   (i) about 0 to less than about 24 mole % of neopentyl glycol residues;
   (ii) 0 to less than about 24 mole % of 1,4-cyclohexanedimethanol residues;
   (iii) about 1 to less than about 15 mole % of total diethylene glycol residues and/or butanediol residues in the final polyester composition;
wherein the total mole % of the dicarboxylic acid component is 100 mole %, and wherein the total mole % of the diol component is 100 mole %; and 40-60 wt % of at least one polyester composition (2) comprising:
at least one polyester which comprises:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
   (i) 15 mole % to less than 30 mole % of 1,4-cyclohexanedimethanol residues;
   (ii) 7 mole % to less than 15 mole % of total diethylene glycol residues and/or butanediol residues in the final polyester composition;
wherein the total mole % of the dicarboxylic acid component is 100 mole %, and wherein the total mole % of the diol component is 100 mole %; and 20-30 wt % at least one at least one polyester composition (3) comprising:
at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 50 mole % or greater of ethylene glycol residues and
about 50 mole % or less of other glycols comprising one or more of:
   (i) 0 mole % to less than about 50 mole % of 1,4-cyclohexanedimethanol residues;
   (ii) about 0.1 mole % to less than about 15 mole % of total diethylene glycol residues and/or butanediol residues in the final polyester composition;
wherein the total mole % of the dicarboxylic acid component is 100 mole %, and wherein the total mole % of the diol component is 100 mole %.

One embodiment of the present disclosure is a multilayer crystallizable film comprising at least one skin layer (A) which comprises a blend of 50-70 wt % at least one polyester composition (1) comprising:
at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
   (i) about 0 to less than about 24 mole % of neopentyl glycol residues;
   (ii) 0 to less than about 24 mole % of 1,4-cyclohexanedimethanol residues;
   (iii) about 1 to less than about 15 mole % of total diethylene glycol residues and/or butanediol residues in the final polyester composition;
wherein the total mole % of the dicarboxylic acid component is 100 mole %, and wherein the total mole % of the diol component is 100 mole %; and 30-50 wt % of at least one polyester composition (2) comprising:
at least one polyester which comprises:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
   (i) 15 mole % to less than 30 mole % of 1,4-cyclohexanedimethanol residues;
   (ii) 7 mole % to less than 15 mole % of total diethylene glycol residues and/or butanediol residues in the final polyester composition;
wherein the total mole % of the dicarboxylic acid component is 100 mole %, and wherein the total mole % of the diol component is 100 mole %; and
at least one core layer (B) which comprises a blend of 30-50 wt % of at least one polyester composition (1) comprising:
at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and

(b) a diol component comprising:
about 75 mole % or greater of ethylene glycol residues and
about 25 mole % or less of other glycols comprising one or more of:
   (i) about 0 to less than about 24 mole % of neopentyl glycol residues;
   (ii) 0 to less than about 24 mole % of 1,4-cyclohexanedimethanol residues;
   (iii) about 1 to less than about 15 mole % of total diethylene glycol residues and/or butanediol residues in the final polyester composition; wherein the total mole % of the dicarboxylic acid component is 100 mole %, and wherein the total mole % of the diol component is 100 mole %; and
50-70 wt % at least one at least one polyester composition (2) comprising:
at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 50 mole % or greater of ethylene glycol residues and
about 50 mole % or less of other glycols comprising one or more of:
   (i) 0 mole % to less than about 50 mole % of 1,4-cyclohexanedimethanol residues;
   (ii) about 0.1 mole % to less than about 15 mole % of total diethylene glycol residues and/or butanediol residues in the final polyester composition;
wherein the total mole % of the dicarboxylic acid component is 100 mole %, and wherein the total mole % of the diol component is 100 mole %.

One embodiment of the present disclosure is a multilayer crystallizable film of the previous embodiments, wherein the polyester composition comprises:
at least one polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
about 80 mole % or greater of ethylene glycol residues and
about 20 mole % or less of other glycols comprising one or more of:
   (i) about 5 to less than about 17 mole % of neopentyl glycol residues;
   (ii) about 2 to less than about 10 mole % of 1,4-cyclohexanedimethanol residues;
   (iii) about 1 to less than about 10 mole % of total diethylene glycol residues and/or butanediol residues in the final polyester composition;
wherein the total mole % of the dicarboxylic acid component is 100 mole %, and wherein the total mole % of the diol component is 100 mole %.

One embodiment of the present disclosure is a multilayer crystallizable film that use 10 wt %-50 wt % recycled polyethylene terephthalate (rPET) flake blended with an amorphous copolyester resin in the core layer and a crystallizable copolyester resin and an amorphous copolyester resin blended in the skin layers.

One embodiment of the present disclosure is a multilayer crystallizable film that use 30 wt %-50 wt % recycled polyethylene terephthalate (rPET) flake blended with an amorphous copolyester resin in the core layer and a crystallizable copolyester resin and an amorphous copolyester resin blended in the skin layers.

In one embodiment, the multilayer crystallizable films have an A-B-A configuration.

In another embodiment, the multilayer crystallizable shrinkable films of the present disclosure are comprised of three layers with an ABA configuration, skin layers (layer A) are comprised of blends of crystallizable resins and copolyester resins and the core layer (layer B) is arranged between the first and second skin layers and is comprised of blends of copolyester resins and rPET in certain optimized ranges.

In one embodiment, the multilayer crystallizable shrinkable films of the present disclosure are comprised of two layers with an AB or BA configuration, the skin layer (layer A) is comprised of blends of crystallizable resins and copolyester resins and the core layer (layer B) is comprised of blends of copolyester resins and rPET in certain optimized ranges.

In one embodiment, the multilayer crystallizable shrinkable films of the present disclosure are comprised of five layers with an ABABA configuration, the skin layers (layer A) are comprised of blends of crystallizable copolyester resins and amorphous copolyester resins and the core layers (layer B) are arranged between the first, third and fifth skin layers, and the core layers are comprised of blends of amorphous copolyester resins and rPET in certain optimized ranges.

In one embodiment, the multilayer crystallizable shrinkable films of the present disclosure are comprised of five layers with an AABAA configuration, the skin layers (layer A) are comprised of blends of crystallizable copolyester resins and amorphous copolyester resins and the core layers (layer B) are arranged between the skin layers, and the core layers are comprised of blends of amorphous copolyester resins and rPET in certain optimized ranges.

In one embodiment, the multilayer crystallizable shrinkable films of the present disclosure are comprised of five layers with an ABCBA configuration, the skin layers (layer A) are comprised of blends of crystallizable copolyester resins and amorphous copolyester resins and the core layers (layer B) are arranged between the skin layers, and the core layers are comprised of blends of amorphous copolyester resins and rPET in certain optimized ranges.

Alternatively, in some embodiments in an ABA or ABCBA configuration the layers, in certain optimized ranges, are comprised of the following:
Layer A is a blend of at least one amorphous copolyester resin and rPET,
Layer B is a blend of at least one crystallizable copolyester resin and an amorphous copolyester resin and rPET, and
Optionally, Layer C is blend of at least one amorphous copolyester resin and rPET; or
Layer A is a blend of at least one amorphous copolyester resin and rPET,
Layer B is a blend of at least one crystallizable copolyester resins and/or rPET, and
Optionally, Layer C is blend of at least one amorphous copolyester resins and rPET; or
Layer A is a blend of at least one amorphous copolyester resin and/or at least one crystallizable copolyesters resin and/or rPET,
Layer B is a blend of at least one amorphous copolyester resins and/or at least one crystallizable copolyester resins and/or rPET, and
Optionally, Layer C is a blend of at least one amorphous copolyester resin and/or at least one crystallizable copolyesters resins and/or rPET.

In one embodiment of the present disclosure the multilayer crystallizable films have a strain induced crystalline melting point of 200° C. or greater. In one embodiment of the present disclosure the multilayer crystallizable films have a strain induced crystalline melting point of 195° C. or greater. In one embodiment of the present disclosure the multilayer crystallizable films have a strain induced crystalline melting point of 190° C. or greater. In one embodiment of the present disclosure the multilayer crystallizable films have a strain induced crystalline melting point of 180° C. or greater. In one embodiment of the present disclosure the multilayer crystallizable films have a strain induced crystalline melting point of 175° C. or greater. In one embodiment of the present disclosure the multilayer crystallizable films have a strain induced crystalline melting point of 170° C. or greater. In one embodiment of the present disclosure the multilayer crystallizable films have a strain induced crystalline melting point of 165° C. or greater. In one embodiment of the present disclosure the multilayer crystallizable films have a strain induced crystalline melting point of 160° C. or greater. In one embodiment of the present disclosure the multilayer crystallizable films have a strain induced crystalline melting point of 150° C. or greater.

In one embodiment the multilayer crystallizable films of the present disclosure have shrinkage in the main shrinkage direction of from 60% or greater when immersed in water at 85° C. for 10 seconds.

In one embodiment the multilayer crystallizable films of the present disclosure have shrinkage in the main shrinkage direction of from 50% or greater when immersed in water at 85° C. for 10 seconds.

In one embodiment the multilayer crystallizable films of the present disclosure have a shrink force of 5 MPa or greater.

In one embodiment of the present disclosure the multilayer crystallizable films are recyclable in a PET recycle stream.

### DETAILED DESCRIPTION

The present disclosure may be understood more readily by reference to the following detailed description of certain embodiments of the disclosure and the working examples. In accordance with the purpose(s) of this disclosure, certain embodiments of the disclosure are described in the Summary of the Invention and are further described herein below. Also, other embodiments of the disclosure are described herein.

Heat-shrinkable plastic films are used as coverings, to hold objects together, and as an outer wrapping for bottles, cans and other kinds of containers. For example, such films are used for covering the cap, neck, shoulder or bulge of bottles or the entire bottle; for the purpose of labeling, protection, parceling, or increasing the value of the product; and for other reasons. In addition, such films may be used as a covering to package such objects as boxes, bottles, boards, rods, or notebooks together in groups, and such films may also be attached closely as a wrapping. The uses mentioned above take advantage of the shrinkability and the internal shrink stress of the film.

Historically, Poly(vinyl chloride) (PVC) films dominated the shrink film market. However, polyester films have become a significant alternative because polyester films do not possess the environmental problems associated with PVC films. Polyester shrink films ideally would have properties very similar to PVC films so that the polyester films can serve as a “drop-in” replacement films and can be processed in existing shrink tunnel equipment. PVC film properties that are desired for duplication include the following: (1) a relatively low shrinkage onset temperature, (2) a total shrinkage which increases gradually and in a controlled manner with increasing temperature, (3) a low shrink force to prevent crushing of the underlying container, (4) a high total shrinkage (for example, 50% or greater), (5) an inherent film toughness so as to prevent unnecessary tearing and splitting of the film prior to and after shrinkage, and (6) a high strain induced crystalline melt temperature.

This disclosure describes unique and unexpected effects measured with certain monomers combinations that improves the recyclability of the multilayer polyester shrink film labels.

Shrink film compositions are used commercially as shrink film labels for food, beverage, personal care, household goods, etc. Often, these shrink films are used in combination with a clear polyethylene terephthalate (PET) bottle or container. The total package (bottle plus label) is then placed in the recycling process. In a typical recycling center, the PET and the shrink film material often end up together at the end of the process due to similarities in composition and density. Drying of the PET flake is required to remove residual water that remains with the PET through the recycling process. Typically, PET is dried at temperatures above 150° C., and in some instances above 200° C. At those temperatures, typical polyester shrink film resins will soften and become sticky, often creating clumps with PET flakes. These clumps must be removed before further processing. These clumps reduce the yield of PET flake from the process and create an additional handling step.

It has been found that certain combinations of glycol monomers in a shrink film resin composition can produce a film with good shrink film performance and also be crystallizable such that it does not impact the recycling of the PET flake during recycling. These crystallizable shrink film resins can be processed with the PET bottle and end up as a component in the recyclable PET flake leaving the recycling process. It has also been found that the choice and quantity of specific combinations of glycol monomers are important to produce films with good shrink film properties and to produce a film that is crystallizable.

There is no limitation on the recycled polyethylene terephthalate (rPET) that may be used in the blend compositions of the present disclosure. In one embodiment the rPET is mechanically recycled. In one embodiment the rPET is produced from chemically recycled monomers (produced by any known methods of depolymerization). In one embodiment, the rPET may have minor modifications such as with up to 5 mole % of isophthalic acid and/or up to 5 mole % of CHDM or other diols. In one embodiment, the recycled PET (rPET) can be virtually any “waste” industrial or post-consumer PET. In one embodiment, the rPET useful in the blend compositions of the present disclosure may be post-consumer recycled PET. In one embodiment, the rPET is post-industrial recycled PET. In one embodiment, the rPET is post-consumer PET from soft drink bottles. In one embodiment, scrap PET fibers, scrap PET films, and poor-quality PET polymers are also suitable sources of rPET. In one embodiment, the recycled PET comprises substantially PET, although other copolyesters can also be used, particularly where they have a similar structure as PET, such as PET copolymers or the like. In one embodiment, the rPET is clean. In one embodiment, the rPET is substantially free of contaminants. In one embodiment, the rPET may be in the form of flakes.

In one embodiment, up to about 50% by weight rPET can be incorporated into the blend compositions of the present disclosure. In one embodiment, up to about 40% by weight rPET can be incorporated into the blend compositions of the present disclosure. In one embodiment, up to about 30% by weight rPET can be incorporated into the blend compositions of the present disclosure. In one embodiment, up to about 20% by weight rPET can be incorporated into the blend compositions of the present disclosure. In one embodiment, the rPET/copolyester blend is 0.1-50 wt % of rPET. In one embodiment, the rPET/copolyester blend is 1-50 wt % of recycled polyethylene terephthalate (rPET). In one embodiment, the rPET/copolyester blend is 10-50 wt % of recycled polyethylene terephthalate (rPET). In one embodiment, the rPET/copolyester blend is 15-50 wt % of recycled polyethylene terephthalate (rPET). In one embodiment, the rPET/copolyester blend is 20-50 wt % of recycled polyethylene terephthalate (rPET). In one embodiment, the rPET/copolyester blend is 20-30 wt % of recycled polyethylene terephthalate (rPET). In one embodiment rPET/copolyester blend is 20-40 wt % of recycled polyethylene terephthalate (rPET) and 30-40 wt % of at least one copolyester. In one embodiment rPET/copolyester blend is 1-50 wt % of recycled polyethylene terephthalate (rPET) and 50-99 wt % of at least one copolyester.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid, for example, p-hydroxybenzoic acid, and the difunctional hydroxyl compound may have an aromatic nucleus bearing 2 hydroxyl substituents, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make a polyester.

The polyesters used in the present disclosure typically can be prepared from dicarboxylic acids and diols which react in substantially equal proportions and are incorporated into the polyester polymer as their corresponding residues. The polyesters of the present disclosure, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 25 mole % 1,4-cyclohexanedimethanol, based on the total diol residues, means the polyester contains 25 mole % 1,4-cyclohexanedimethanol residues out of a total of 100 mole % diol residues. Thus, there are 25 moles of 1,4-cyclohexanedimethanol residues among every 100 moles of diol residues.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present disclosure. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the present disclosure. In embodiments, ranges of from 70 to 100 mole %; or 80 to 100 mole %; or 90 to 100 mole %; or 95 to 100 mole %; or 99 to 100 mole %; or 99.9 to 100 mole %; or 100 mole % terephthalic acid and/or dimethyl terephthalate and/or mixtures thereof may be used.

In addition to terephthalic acid, the dicarboxylic acid component of the polyesters useful in the present disclosure can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present disclosure include but are not limited to those having up to 20 carbon atoms, and which can be linear, para-oriented, or symmetrical. Examples of modifying aromatic dicarboxylic acids which may be used in this disclosure include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful in the present disclosure can be further modified with up to 10 mole %, such as up to 5 mole % or up to 1 mole % of one or more aliphatic dicarboxylic acids containing 2-16 carbon atoms, for example, cyclohexanedicarboxylic, malonic, succinic, glutaric, adipic, pimelic, suberic, azelaic and/or dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the polyesters and are useful in the present disclosure.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In another embodiment, at least a portion of the residues derived from dicarboxylic acids and glycols as set forth herein, are derived from recycled monomeric species such as recycled dimethylterephthalate (rDMT), recycled terephthalic acid (rTPA), recycled dimethylisopthalate (rDMI), recycled ethylene glycol (rEG), recycled cyclohexanedimethanol (rCHDM), recycled neopentyl glycol (rNPG), recycled 2,2,4,4-tetramethyl-1,3-cyclobutanediol (rTMCD), and recycled diethylene glycol (rDEG). Such recycled monomeric species can be obtained from known methanolysis or glycolysis reactions which are utilized to depolymerize various post-consumer recycled polyesters and copolyesters. Similarly, recycled poly(ethylene terephthalate) (rPET) can be utilized as a feedstock (for the dicarboxylic acid and glycol components) in the manufacturing of polyesters of the invention having recycle content. Accordingly, in another embodiment, the polyester compositions of the invention comprise at least a portion of the dicarboxylic acid residues and/or glycol residues are derived from (i) recycled monomeric species chosen from rDMT, rTPA, rDMI, rEG, rCHDM, rDEG, rTMCD, INPG and (ii) rPET.

In one embodiment, the diol component of the polyester compositions useful in the present disclosure can comprise 1,4-cyclohexanedimethanol. In another embodiment, the diol component of the polyester compositions useful in the present disclosure comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

The diol component of the polyester compositions and the crystallizable copolyester compositions useful in the present disclosure can include, but is not limited to, compositions wherein the sum of the residues of 1,4-cyclohexanedimethanol and residues of neopentyl glycol in the final polyester composition is from 0 to 30 mole %, or from 1 to 30 mole %, or from 1 to 25 mole %, 1 to 20 mole %, or from 1 to 15 mole %, or from 1 to 10 mole %, or from 2 to 30 mole %, or from 2 to 25 mole %, or from 2 to 20 mole %, or from 2 to 15 mole %, or from 2 to 10 mole %, or from 3 to 30 mole %, or from 3 to 25 mole %, or from 3 to 20 mole %, or from 3 to 15 mole %, or from 3 to 10 mole %, 4 to 30 mole %, or from 4 to 25 mole %, 4 to 20 mole %, or from 4 to 15 mole %, or from 4 to 10 mole %, 5 to 30 mole %, or from 5 to 25 mole %, 5 to 20 mole %, or from 5 to 15 mole %, or from 5 to 10 mole %, 6 to 30 mole %, or from 6 to 25 mole %, 6 to 20 mole %, or from 6 to 15 mole %, or from 6 to 10 mole %, 7 to 30 mole %, or from 7 to 25 mole %, 7 to 20 mole %, or from 7 to 15 mole %, or from 7 to 10 mole %, 8 to 30 mole %, or from 8 to 25 mole %, 8 to 20 mole %, or from 8 to 15 mole %, or from 8 to 10 mole %, 9 to 30 mole %, or from 9 to 25 mole %, 9 to 20 mole %, or from 9 to 15 mole %, or from 9 to 10 mole %, 10 to 30 mole %, or from 10 to 25 mole %, 10 to 20 mole %, or from 10 to 15 mole %, or from 11 to 30 mole %, 11 to 30 mole %, or from 11 to 25 mole %, 11 to 20 mole %, or from 11 to 15 mole %, or from 12 to 30 mole %, 12 to 25 mole %, or from 12 to 20 mole %, 12 to 15 mole %, or from 13 to 30 mole %, or from 13 to 25 mole %, 13 to 20 mole %, or from 13 to 15 mole %, 14 to 30 mole %, or from 14 to 25 mole %, or from 14 to 20 mole %, 14 to 15 mole %, or from 15 to 30 mole %, 15 to 25 mole %, or from 15 to 20 mole %, or from 16 to 20 mole %, 18 to 20 mole %, or from 10 to 18 mole %, 16 to 18 mole %, or from 12 to 16 mole %, or from 16 to 20 mole %, or from 14 to 18 mole %, or from 11 to 30 mole %, or from 13 to 30 mole %, or from 14 to 30 mole %, or from 10 to 29 mole %, or from 11 to 29 mole %, or from 12 to 29 mole %, or from 13 to 29 mole %, or from 14 to 29 mole %, or from 15 to 29 mole %, or from 10 to 28 mole %, or from 11 to 28 mole %, or from 12 to 28 mole %, or from 13 to 28 mole %, or from 14 to 28 mole %, or from 15 to 28 mole %. In one embodiment, the sum of residues of 1,4-cyclohexanedimethanol and residues of neopentyl glycol in the final polyester composition can be from 4 to 15 mole %, or from 2 to 21 mole %, or from 2 to less than 20 mole %, or from 4 to 20 mole %, or from 5 to 18 mole %, or from 10 to 21 mole %, or from 12 to 21 mole %, wherein the total mole % of the diol component is 100 mole %.

In one embodiment, the diol component of the polyester compositions useful in this disclosure can contain 0 to 30 mole % of neopentyl glycol based on the total mole % of the diol component being 100 mole %. In one embodiment, the diol component of the polyester compositions useful in this disclosure can contain 0 to 25 mole % of neopentyl glycol based on the total mole % of the diol component being 100 mole %. In one embodiment, the diol component of the polyester compositions and the polyester blend compositions useful in this disclosure can contain 0 to 20 mole % of neopentyl glycol based on the total mole % of the diol component being 100 mole %. In one embodiment, the diol component of the polyester compositions and polyester blend compositions useful in this disclosure can contain 0 to 17 mole % of neopentyl glycol based on the total mole % of the diol component being 100 mole %. In one embodiment, the diol component of the polyester compositions and polyester blend compositions useful in this disclosure can contain 5 to 20 mole % of neopentyl glycol based on the total mole % of the diol component being 100 mole %. In one embodiment, the diol component of the polyester compositions and polyester blend compositions useful in this disclosure can contain 10 to 20 mole % of neopentyl glycol based on the total mole % of the diol component being 100 mole %. In one embodiment, the diol component of the polyester compositions and polyester blend compositions useful in this disclosure can contain 10 to 15 mole % of neopentyl glycol based on the total mole % of the diol component being 100 mole %. In one embodiment, the diol component of the polyester compositions and polyester blend compositions useful in this disclosure can contain 15 to 25 mole % of neopentyl glycol based on the total mole % of the diol component being 100 mole %.

In one embodiment, the diol component of the polyester compositions useful in the present disclosure can contain from 0 to 50 mole %, or from 0.01 to 50 mole %, 0 to 40 mole %, or from 0.01 to 40 mole %, 0 to 30 mole %, or from 0.01 to 30 mole %, or from 0 to 25 mole %, or from 0.1 to 25 mole %, or from 0 to 20 mole %, or from 0.1 to 20 mole %, or from 2 to 20 mole %, or from 0.01 to 15 mole %, or from 0.01 to 14 mole %, or from 0.01 to 13 mole %, or from 0.01 to 12 mole %, or from 0.01 to 11 mole %, or 0.01 to 10 mole %, or from 0.01 to 9 mole %, or from 0.01 to 8 mole %, or from 0.01 to 7 mole %, or from 0.01 to 6 mole %, or from 0.01 to 5 mole %, 3 to 15 mole %, or from 3 to 14 mole %, or from 3 to 13 mole %, or from 3 to 12 mole %, or from 3 to 11 mole %, or 3 to 10 mole %, or from 3 to 9 mole %, or from 3 to 8 mole %, or from 3 to 7 mole %, or from 2 to 10 mole %, or from 2 to 9 mole %, or from 2 to 8 mole %, or from 2 to 7 mole %, or from 2 to 5 mole %, or from 1 to 7 mole %, or from 1 to 5 mole %, or from 1 to 3 mole %, or from 15 to 30 mole %, or from 15 to 20 mole %, or from 10 to 30 mole %, or from 10 to 20 mole %, of 1,4-cyclohexanedimethanol residues, based on the total mole % of the diol component being 100 mole %.

In one embodiment, the diol component of the polyester compositions useful in the present disclosure can contain 0.01 to 15 mole % of 1,4-cyclohexanedimethanol based on the total mole % of the diol component being 100 mole %. In one embodiment, the diol component of the polyester compositions useful in this disclosure can contain 0 to less than 15 mole % of 1,4-cyclohexanedimethanol based on the total mole % of the diol component being 100 mole %. In one embodiment, the diol component of the polyester compositions useful in this disclosure can contain 0.01 to 10 mole % of 1,4-cyclohexanedimethanol based on the total mole % of the diol component being 100 mole %. In one embodiment, the diol component of the polyester compositions useful in this disclosure can contain 0 to less than 10 mole % of 1,4-cyclohexanedimethanol based on the total mole % of the diol component being 100 mole %. In one embodiment, the diol component of the polyester compositions useful in this disclosure can contain 0.01 to 5 mole % of 1,4-cyclohexanedimethanol based on the total mole % of the diol component being 100 mole %. In one embodiment, the diol component of the polyester compositions useful in this disclosure can contain 0 to less than 5 mole % of 1,4-cyclohexanedimethanol based on the total mole % of the diol component being 100 mole %.

It should be understood that some other diol residues may be formed in situ during processing. The total amount of diethylene glycol residues can be present in the polyester useful in the present disclosure, whether or not formed in situ during processing or intentionally added, or both, in any amount, for example, from 0.1 to 15 mole %, or from 1 to 15 mole %, or from 2 to 15 mole %, or from 5 to 15 mole %, or from 7 to 15 mole %, or from 2 to 12 mole %, or from 2 to 11 mole %, or 2 to 10 mole %, or from 2 to 9 mole %, or from 3 to 12 mole %, or from 3 to 11 mole %, or 3 to 10 mole %, or from 3 to 9 mole %, or from 4 to 12 mole %, or from 4 to 11 mole %, or 4 to 10 mole %, or from 4 to 9 mole %, or, from 5 to 12 mole %, or from 5 to 11 mole %, or 5 to 10 mole %, or from 5 to 9 mole %, of diethylene glycol residues, based on the total mole % of the diol component being 100 mole %.

In one embodiment, the total amount of diethylene glycol residues can be present in the polyester useful in the present disclosure, whether or not formed in situ during processing or intentionally added or both, can be from 4 mole % or less, or from 3.5 mole % or less, or from 3.0 mole % or less, or from 2.5 mole % or less, or from 2.0 mole % or less, or from 1.5 mole % or less, or from 1.0 mole % or less, or from 1 to 4 mole %, or from 1 to 3 mole %, or from 1 to 2 mole % of diethylene glycol residues, or from 2 to 8 mole %, or from 2 to 7 mole %, or from 2 to 6 mole %, or from 2 to 5 mole %, or from 3 to 8 mole %, or from 3 to 7 mole %, or from 3 to 6 mole %, or from 3 to 5 mole %, or in some embodiments there is no intentionally added diethylene glycol residues, based on the total mole % of the diol component being 100 mole %. In certain embodiments, the polyester contains no added modifying diols.

For all embodiments, the remainder of the diol component can comprise ethylene glycol residues in any amount based on the total mole % of the diol component being 100 mole %. In one embodiment, the polyester portion of the polyester compositions useful in the present disclosure can contain 50 mole % or greater, or 55 mole % or greater, or 60 mole % or greater, or 65 mole % or greater, or 70 mole % or greater, or 75 mole % or greater, or 80 mole % or greater, or 85 mole % or greater, or 90 mole % or greater, or 95 mole % or greater, or from 50 to 80 mole %, or from 55 to 80 mole %, or from 60 to 80 mole %, or from 50 to 75 mole %, or from 55 to 75 mole %, or from 60 to 75 mole %, or from 65 to 75 mole % of ethylene glycol residues, based on the total mole % of the diol component being 100 mole %.

In one embodiment, the diol component of the polyester compositions useful in the present disclosure can contain up to 20 mole %, or up to 19 mole %, or up to 18 mole %, or up to 17 mole %, or up to 16 mole %, or up to 15 mole %, or up to 14 mole %, or up to 13 mole %, or up to 12 mole %, or up to 11 mole %, or up to 10 mole %, or up to 9 mole %, or up to 8 mole %, or up to 7 mole %, or up to 6 mole %, or up to 5 mole %, or up to 4 mole %, or up to 3 mole %, or up to 2 mole %, or up to 1 mole %, or less of one or more modifying diols (modifying diols are defined as diols which are not ethylene glycol, diethylene glycol, neopentyl glycol, or 1,4-cyclohexanedimethanol). In certain embodiments, the polyesters useful in this disclosure can contain 10 mole % or less of one or more modifying diols. In certain embodiments, the polyesters useful in this disclosure can contain 5 mole % or less of one or more modifying diols. In certain embodiments, the polyesters useful in this disclosure can contain 3 mole % or less of one or more modifying diols. In another embodiment, the polyesters useful in this disclosure can contain 0 mole % modifying diols. It is contemplated, however, that some other diol residuals may form in situ so that residual amounts formed in situ are also an embodiment of this disclosure.

In embodiments, modifying diols suitable for use in the polyesters, if used, as defined herein contain 2 to 16 carbon atoms. Examples of modifying diols include, but are not limited to, 1,2-propanediol, 1,3-propanediol, isosorbide, 1,4-butanediol, 1,5-pentanediol, 1,6-hexanediol, p-xylene glycol, polytetramethylene glycol, 2,2,4,4-tetramethyl-1,3-cyclobutanediol (TMCD) and mixtures thereof. In one embodiment, isosorbide is a modifying diol. In another embodiment, the modifying diols include, but are not limited to, at least one of 1,3-propanediol and 1,4-butanediol. In one embodiment, 1,3-propanediol and/or 1,4-butanediol can be excluded. If 1,4- or 1,3-butanediol are used, greater than 4 mole % or greater than 5 mole % can be provided in one embodiment. In one embodiment, at least one modifying diol is 1,4-butanediol which present in the amount of 0 to 25 mole %. In one embodiment, at least one modifying diol is 1,4-butanediol which present in the amount of 5 to 25 mole %.

In one embodiment, a multilayer shrink film is provided comprising a polyester composition further comprising: 1,4-cyclohexanedimethanol residues are present in the amount of 0.01 to about 10 mole %, diethylene glycol residues are present in the amount of 2 to 9 mole %, neopentyl glycol residues in the amount of 5 to 30 mole %, and ethylene glycol residues are present in the amount of 60 mole % or greater, based on the total mole % of the diol component being 100 mole %.

In one embodiment, a multilayer shrink film is provided comprising a polyester composition further comprising: 1,4-cyclohexanedimethanol residues are present in the amount of 0.01 to about 30 mole %, diethylene glycol residues are present in the amount of 2 to 15 mole %, neopentyl glycol residues in the amount of 0 to 30 mole %, and ethylene glycol residues are present in the amount of 60 mole % or greater, based on the total mole % of the diol component being 100 mole %.

In some embodiments, the polyesters according to the present disclosure can comprise from 0 to 10 mole %, for example, from 0.01 to 5 mole %, from 0.01 to 1 mole %, from 0.05 to 5 mole %, from 0.05 to 1 mole %, or from 0.1 to 0.7 mole %, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In some embodiments, the polyester(s) useful in the present disclosure can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole % of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters useful in the present disclosure can comprise at least one chain extender. Suitable chain extenders include, but are not limited to, multifunctional (including, but not limited to, bifunctional) isocyanates, multifunctional epoxides, including, for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion.

The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

It is contemplated that polyester compositions useful in the present disclosure can possess at least one of the inherent viscosity ranges described herein and at least one of the monomer ranges for the polyester compositions described herein, unless otherwise stated. It is also contemplated that polyester compositions useful in the present disclosure can possess at least one of the Tg ranges described herein and at least one of the monomer ranges for the polyester compositions described herein, unless otherwise stated. It is also contemplated that polyester compositions useful in the present disclosure can possess at least one of the inherent viscosity ranges described herein, at least one of the Tg ranges described herein, and at least one of the monomer ranges for the polyester compositions described herein, unless otherwise stated.

For embodiments of this disclosure, the polyesters useful in this disclosure can exhibit at least one of the following inherent viscosities as determined in 60/40 (wt/wt) phenol/tetrachloroethane at a concentration of 0.25 g/50 ml at 25° C.: 0.50 to 1.2 dL/g; 0.50 to 1.0 dL/g; 0.50 to 0.90 dL/g; 0.50 to 0.80 dL/g; 0.55 to 0.80 dL/g; 0.60 to 0.80 dL/g; 0.65 to 0.80 dL/g; 0.70 to 0.80 dL/g; 0.50 to 0.75 dL/g; 0.55 to 0.75 dL/g; or 0.60 to 0.75 dL/g.

The glass transition temperature (Tg) of the polyesters is determined using a TA DSC 2920 from Thermal Analyst Instrument at a scan rate of 20° C./min.

In certain embodiments, the multilayer oriented films or multilayer shrink films of this disclosure comprise polyesters/polyester compositions wherein the polyester has a Tg of 60 to 80° C.; 70 to 80° C.; or 65 to 80° C.; or 65 to 75° C. In certain embodiments, these Tg ranges can be met with or without at least one plasticizer being added during polymerization.

In embodiments of the present disclosure, certain multilayer oriented films and/or multilayer shrinkable films comprising the polyesters and/or polyester compositions useful in this disclosure can have a unique combination of all of the following properties: good stretchability, controlled shrinkage properties, certain toughness, certain inherent viscosities, certain glass transition temperatures (Tg), certain strain induced crystalline melting points, certain flexural modulus, certain densities, certain tensile modulus, certain surface tension, good melt viscosity, good clarity, good color, and recyclability.

In one embodiment, certain polyester compositions useful in this disclosure can be visually clear. The term “visually clear” is defined herein as an appreciable absence of cloudiness, haziness, and/or muddiness, when inspected visually.

The polyester portion of the polyester compositions useful in this disclosure can be made by processes known from the literature, for example, by processes in homogenous solution, by transesterification processes in the melt, and by two phase interfacial processes. Suitable methods include, but are not limited to, the steps of reacting one or more dicarboxylic acids with one or more diols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general may be prepared by condensing the dicarboxylic acid or dicarboxylic acid ester with the diol in the presence of a catalyst at elevated temperatures increased gradually during the course of the condensation up to a temperature of about 225° C. to 310° C., in an inert atmosphere, and conducting the condensation at low pressure during the latter part of the condensation, as described in further detail in U.S. Pat. No. 2,720,507 incorporated herein by reference herein.

In some embodiments, during the process for making the polyesters useful in the present disclosure, certain agents which colorize the polymer can be added to the melt including toners or dyes. In one embodiment, a bluing toner is added to the melt in order to reduce the b* of the resulting polyester polymer melt phase product. Such bluing agents include blue inorganic and organic toner(s) and/or dyes. In addition, red toner(s) and/or dyes can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Preferably, the toner(s) are added to the esterification zone or to the early stages of the polycondensation zone, such as to a prepolymerization reactor.

The present disclosure further relates to polymer blends. In one embodiment, the polymer blend comprises:
(a) from 5 to 95 weight % of the polyester compositions of the disclosure described herein; and
(b) from 5 to 95 weight % of at least one polymeric component.

Suitable examples of the polymeric components include, but are not limited to, nylon; polyesters different than those described herein; polyamides such as ZYTEL® from DuPont; polystyrene; polystyrene copolymers; styrene acrylonitrile copolymers; acrylonitrile butadiene styrene copolymers; poly(methyl methacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the foregoing polymers. In one embodiment, aliphatic-aromatic polyesters can be excluded from the polyester compositions useful in this disclosure. The following polyesters, which can be blended to make the polyester compositions of this disclosure, can be excluded as the polymeric components used in additional blending if such blending exceeds the compositional ranges of the disclosure: polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), poly(butylene terephthalate) and/or diethylene glycol modified PET (EASTOBOND™ copolyester).

The blends can be prepared by conventional processing techniques known in the art, such as melt blending or solution blending.

In embodiments, the polyester compositions and the polymer blend compositions can also contain from 0.01 to 25% by weight of the overall composition common additives such as colorants, toner(s), dyes, mold release agents, flame retardants, plasticizers, glass bubbles, nucleating agents, stabilizers, including but not limited to, UV stabilizers, thermal stabilizers, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials may be added to the compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

In one embodiment, the multilayer films and the multilayer shrink films according to the present disclosure may contain from 0.01 to 10 weight percent of the polyester plasticizer. In one embodiment, the multilayer shrink films can contain from 0.1 to 5 weight percent of the polyester plasticizer. Generally, the multilayer shrink films can contain from 90 to 99.99 weight percent of the copolyester. In certain embodiments, the multilayer shrink films can contain from 95 to 99.9 weight percent of the copolyester.

In one aspect, the present disclosure relates to multilayer shrink film(s) and molded article(s) of this disclosure comprising the polyester compositions and/or polymer blends useful in this disclosure. The methods of forming the polyesters and/or blends into film(s) and/or sheet(s) are well known in the art. Examples of film(s) and/or sheet(s) useful the present disclosure include but not are limited to extruded film(s) and/or sheet(s), compression molded film(s), calendered film(s) and/or sheet(s), solution casted film(s) and/or sheet(s). In one aspect, methods of making film and/or sheet useful to produce the shrink films of the present disclosure include but are not limited to extrusion, compression molding, calendering, and solution casting.

In one embodiment, the polyester compositions useful in this disclosure are made into film using any method known in the art to produce films from polyesters, for example, solution casting, extrusion, compression molding, or calendering.

In one embodiment, the as-formed film is then oriented in one or more directions (e.g., monoaxially and/or biaxially oriented film). This orientation of the film can be performed by any method known in the art using standard orientation conditions. For example, the oriented films of the disclosure can be made from films having a thickness of about 100 to 400 microns, for example, extruded, cast or calendered films, which can be oriented at a ratio of 5:1 to 3:1 at a temperature of from Tg to Tg+55° C. or from 70° C. to 125° C., for example, at a ratio of 5:1 or of 3:1 at a temperature from 70° C. to 100° C., and which can be oriented to a thickness of 20 to 80 microns. In one embodiment, the orientation of the initial pre-shrunk film can be performed on a tenter frame according to these orientation conditions.

The shrink films of the present disclosure can have an onset of shrinkage temperature of from about 55 to about 80° C., or about 55 to about 75° C., or about 55 to about 70° C. Shrink initiation temperature is the temperature at which the onset of shrinking occurs.

In certain embodiments, the polyester compositions useful in the present disclosure can have densities of 1.6 g/cc or less, or 1.5 g/cc or less, or 1.4 g/cc or less, or 1.1 g/cc to 1.5 g/cc, or 1.2 g/cc to 1.4 g/cc, or 1.2 g/cc to 1.35 g/cc.

In one embodiment, the density of the films is reduced by introducing many small voids or holes into the film or shaped article. This process is called “voiding” and may also be referred to as “cavitating” or “microvoiding”. Voids are obtained by incorporating about 1 to about 50 weight % of small organic or inorganic particles (including glass microspheres) or “inclusions” (referred in the art as “voiding” or “cavitation” agents) into a matrix polymer and orienting the polymer by stretching in at least one direction. During stretching, small cavities or voids are formed around the voiding agent. When voids are introduced into polymer films, the resulting voided film not only has a lower density than the non-voided film, but also becomes opaque and develops a paper-like surface. This surface also has the advantage of increased printability; that is, the surface is capable of accepting many inks with a substantially greater capacity over a non-voided film. Typical examples of voided films are described in U.S. Pat. Nos. 3,426,754; 3,944,699; 4,138,459; 4,582,752; 4,632,869; 4,770,931; 5,176,954; 5,435,955; 5,843,578; 6,004,664; 6,287,680; 6,500,533; 6,720,085; U.S. Patent Application Publication No.'s 2001/0036545; 2003/0068453; 2003/0165671; 2003/0170427; Japan Patent Application No.'s 61-037827; 63-193822; 2004-181863; European Patent No. 0 581 970 B1, and European Patent Application No. 0 214 859 A2.

In certain embodiments, the extruded multilayer films are oriented while they are stretched. The oriented multilayer films or multilayer shrinkable films of the present disclosure can be made from films having any thickness depending on the desired end-use. The desirable conditions are, in one embodiment, where the oriented films and/or shrinkable films can be printed with ink for applications including labels, photo films which can be adhered to substrates such as paper, and/or other applications that it may be useful in. It may be desirable to coextrude the polyesters useful in the present disclosure with another polymer, such as PET, to make the films useful in making the oriented films and/or shrink films of this disclosure. One advantage of doing the latter is that a tie layer may not be needed in some embodiments.

In one embodiment, the monoaxially and biaxially oriented films of the present disclosure can be made from films having a thickness of about 100 to 400 microns, for example, extruded, cast or calendered films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as-extruded film can be performed on a tenter frame according to these orientation conditions. The shrink films of the present disclosure can be made from the oriented films of this disclosure.

In certain embodiments, the shrink films of the present disclosure have gradual shrinkage with little to no wrinkling. In certain embodiments, the shrink films of the present disclosure have no more than 40% shrinkage in the transverse direction per 5° C. temperature increase increment.

In certain embodiments of the present disclosure, the shrink films of this disclosure have shrinkage in the machine direction of from 10% or less, or 5% or less, or 3% or less, or 2% or less, or no shrinkage when immersed in water at 65° C. for 10 seconds. In certain embodiments of the present disclosure, the shrink films of this disclosure have shrinkage in the machine direction of from −10% to 10%, −5% to 5%, or −5% to 3%, or −5% to 2%, or −4% to 4%, or −3% to 4% or −2% to 4%, or −2% to 2.5%, or −2% to 2%, or 0 to 2%, or no shrinkage, when immersed in water at 65° C. for 10 seconds. Negative machine direction shrinkage percentages here indicate machine direction growth. Positive machine direction shrinkages indicate shrinkage in the machine direction.

In certain embodiments of the present disclosure, the multilayer shrink films of this disclosure have shrinkage in the main shrinkage direction of from 50% or greater, or 60% or greater, or 70% or greater, when immersed in water at 95° C. for 10 seconds.

In certain embodiments of the present disclosure, the multilayer shrink films of this disclosure have shrinkage in the main shrinkage direction in the amount of 50 to 90% and shrinkage in the machine direction of 10% or less, or from −10% to 10%, when immersed in water at 95° C. for 10 seconds.

In one embodiment, the polyesters useful in the present disclosure are made into films using any method known in the art to produce films from polyesters, for example, solution casting, extrusion, compression molding, or calendaring. The as-extruded (or as-formed) film is then oriented in one or more directions (e.g., monoaxially and/or biaxially oriented film). This orientation of the films can be performed by any method known in the art using standard orientation conditions. For example, the monoaxially oriented films of the present disclosure can be made from films having a thickness of about 100 to 400 microns, such as, extruded, cast or calendared films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as extruded film can be performed on a tenter frame according to these orientation conditions.

In certain embodiments of the present disclosure, the multilayer shrink films of this disclosure have no more than 40% shrinkage in the transverse direction per 5° C. temperature increase increment.

In certain embodiments of the present disclosure, the multilayer shrink films of this disclosure can have an onset of shrinkage temperature of from about 55 to about 80° C., or about 55 to about 75° C., or 55 to about 70° C. Onset of shrinkage temperature is the temperature at which onset of shrinking occurs.

In certain embodiments of the present disclosure, the multilayer shrink films of this disclosure can have an onset of shrinkage temperature of between 55° C. and 70° C.

In certain embodiments of the present disclosure, the multilayer shrink films of this disclosure can have a break strain percentage greater than 100% at a stretching speed of 300 mm/minute in the direction orthogonal to the main shrinkage direction according to ASTM Method D882.

In certain embodiments of the present disclosure, the multilayer shrink films of this disclosure can have a break strain percentage of greater than 300% at a stretching speed of 300 mm/minute in the direction orthogonal to the main shrinkage direction according to ASTM Method D882.

In certain embodiments of the present disclosure, the multilayer shrink films of this disclosure can have a tensile stress at break (break stress) of from 20 to 400 MPa; or 40 to 260 MPa; or 42 to 260 MPa as measured according to ASTM Method D882.

In certain embodiments of the present disclosure, the multilayer shrink films of this disclosure can have a shrink force of from 2 to 18 MPa, or from 4 to 15 MPa, as measured by ISO Method 14616 depending on the stretching conditions and the end-use application desired. For example, certain labels made for plastic bottles can have an MPa of from 4 to 8 and certain labels made for glass bottles can have a shrink force of from 10 to 14 MPa as measured by ISO Method 14616 using a Shrink Force Tester made by LabThink @ 80° C.

In one embodiment of the present disclosure, the polyester compositions can be formed by reacting the monomers by known methods for making polyesters in what is typically referred to as reactor grade compositions.

In one embodiment of the present disclosure, the polyester compositions of this disclosure can be formed by blending polyesters, such as polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), poly(butylene terephthalate) and/or diethylene glycol modified PET (EASTOBOND™ copolyester) to achieve the monomer ranges of these compositions.

In certain embodiments, the polyester compositions and the polymer blend compositions can also contain from 0.01 to 25% by weight of the overall composition common additives such as colorants, toner(s), dyes, mold release agents, flame retardants, plasticizers, glass bubbles, nucleating agents, stabilizers, including but not limited to, UV stabilizers, thermal stabilizers and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials can be added to the polyester compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

Molded articles can also be manufactured from any of the polyester compositions disclosed herein which may or may not consist of or contain shrink films and are included within the scope of the present disclosure.

Generally, the multilayer shrink films according to the present disclosure may contain from 0.01 to 10 weight percent of the polyester plasticizer. In one embodiment, the multilayer shrink films can contain from 0.1 to 5 weight percent of the polyester plasticizer. Generally, the multilayer shrink films can contain from 90 to 99.99 weight percent of the copolyester. In certain embodiments, the multilayer shrink films can contain from 95 to 99.9 weight percent of the copolyester.

In one embodiment, when having a pre-oriented thickness of about 100 to 400 microns followed by orientation on a tenter frame at from a ratio of 6.5:1 to 3:1 at a temperature of from Tg to Tg+55° C. to a thickness of from about 20 to about 80 microns, the multilayer shrink films of the present disclosure can have one or more of the following properties:
(1) shrinkage in the main shrinkage direction or transverse direction in the amount of greater than 50% (or greater than 60%, or greater than 70%), and 10% or less (or from −5% to 4%) shrinkage in the machine direction when immersed in water at 95° C. for 10 seconds; (2) an onset of shrinkage temperature of from about 55° C. to about 70° C.; (3) a break strain percentage of greater than 100% at stretching speeds of 300 mm/minute, or 200 to 600%, or 200 to 500%, or 226 to 449%, or 250 to 455% in the transverse direction or in the machine direction or in both directions according to ASTM Method D882; (4) no more than 40% shrinkage per each 5° C. temperature increase increment; and/or (5) strain induced crystalline melting point greater than 200° C. Any combination of these properties or all of these properties can be present in the shrink films of this disclosure. The shrink films of the present disclosure can have a combination of two or more of the above described shrink film properties. The shrink films of the present disclosure can have a combination of three or more of the above described shrink film properties. The shrink films of the present disclosure can have a combination of four or more of the above described shrink film properties. In certain embodiments, properties (1)-(2) are present. In certain embodiments, properties (1)-(5) are present. In certain embodiments, properties (1)-(3) are present, etc.

The shrinkage percentages herein are based on initial as-formed films having a thickness of about 20 to 80 microns that have been oriented at a ratio of from 6.5:1 to 3:1 at a temperature of Tg to Tg+55° C. on a tenter frame, for example, at a ratio of 5:1 at a temperature from 70° C. to 85° C. In one embodiment, the shrinkage properties of the oriented films used to make the shrink films of this disclosure were not adjusted by annealing the films at a temperature higher than the temperature in which it was oriented.

The shape of the films useful in making the oriented multilayer films or multilayer shrink films of the present disclosure is not restricted in any way. For example, it may be a flat film or a film that has been formed into a tube. In order to produce the multilayer shrink films useful in the present disclosure, the polyester is first formed into a flat film and then is “uniaxially stretched”, meaning the polyester film is oriented in one direction. The films could also be “biaxially oriented,” meaning the polyester films are oriented in two different directions; for example, the films are stretched in both the machine direction and a direction different from the machine direction. Typically, but not always, the two directions are substantially perpendicular. For example, in one embodiment, the two directions are in the longitudinal or machine direction (“MD”) of the film (the direction in which the film is produced on a film-making machine) and the transverse direction (“TD”) of the film (the direction perpendicular to the MD of the film). Biaxially oriented films may be sequentially oriented, simultaneously oriented, or oriented by some combination of simultaneous and sequential stretching.

The multilayer films may be oriented by any usual method, such as the roll stretching method, the long-gap stretching method, the tenter-stretching method, and the tubular stretching method. With use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also, the stretching may be done first in one direction and then in the other direction to result in effective biaxial stretching. In one embodiment, stretching of the films is done by preliminarily heating the films 5° C. to 80° C. above their glass transition temperature (Tg). In one embodiment, the films can be preliminarily heated from 10° C. to 30° C. above their Tg. In one embodiment, the stretch rate is from 5 to 20 inches (12.7 to 50.8 cm) per second. Next, the multilayer films can be oriented, for example, in either the machine direction, the transverse direction, or both directions from 2 to 6 times the original measurements. The multilayer films can be oriented as a single film layer or can be coextruded with another polyester such as PET (polyethylene terephthalate) as a multilayer film and then oriented.

In one embodiment, the present disclosure includes an article of manufacture or a shaped article comprising the multilayer shrink films of any of the multilayer shrink film embodiments of this disclosure. In another embodiment, the present disclosure includes an article of manufacture or a shaped article comprising the multilayer oriented films of any of the multilayer oriented film embodiments of this disclosure.

In certain embodiments, the present disclosure includes but is not limited to multilayer shrink films applied to containers, plastic bottles, glass bottles, packaging, batteries, hot fill containers, and/or industrial articles or other applications. In one embodiment, the present disclosure includes but is not limited to oriented films applied to containers, packaging, plastic bottles, glass bottles, photo substrates such as paper, batteries, hot fill containers, and/or industrial articles or other applications.

In certain embodiments of the present disclosure, the multilayer shrink films of this disclosure can be formed into a label or sleeve. The label or sleeve can then be applied to an article of manufacture, such as, the wall of a container, battery, or onto a sheet or film.

The multilayer oriented films or multilayer shrink films of the present disclosure can be applied to shaped articles, such as, sheets, films, tubes, bottles and are commonly used in various packaging applications. For example, films and sheets produced from polymers such as polyolefins, polystyrene, poly(vinyl chloride), polyesters, polylactic acid (PLA) and the like are used frequently for the manufacture of shrink labels for plastic beverage or food containers. For example, the multilayer shrink films of the present disclosure can be used in many packaging applications where the multilayer shrink film applied to the shaped article exhibits properties, such as, good printability, high opacity, higher shrink force, good texture, and good stiffness.

The combination of the improved shrink properties as well as the improved toughness should offer new commercial options, including but not limited to, multilayer shrink films applied to containers, plastic bottles, glass bottles, packaging, batteries, hot fill containers, and/or industrial articles or other applications.

In one aspect of the present disclosure, the disclosed polyester compositions are useful as thermoformed and/or thermoformable film(s) or sheet(s). The present disclosure is also directed to articles of manufacture which incorporate the thermoformed film(s) and/or sheet(s) of this disclosure. In one embodiment, the polyesters compositions of the present disclosure are useful as films and sheets which are easily formed into shaped or molded articles. In one embodiment, the film(s) and/or sheet(s) of the present disclosure may be processed into molded articles or parts by thermoforming. The polyester compositions of the present disclosure may be used in a variety of molding and extrusion applications.

In addition, in one embodiment, the polyester compositions and the polyester blend compositions useful in the thermoformed sheet(s) of this disclosure may also contain from 0.1 to 25% by weight of the overall composition common additives such as colorants, mold release agents, flame retardants, plasticizers, nucleating agents, stabilizers, including but not limited to, UV stabilizers, thermal stabilizers, fillers, and impact modifiers.

In one embodiment, reinforcing materials may be included in the thermoformed film(s) or sheet(s) comprising the polyester compositions of this disclosure. For examples, suitable the reinforcing materials may include carbon filaments, silicates, mica, clay, talc, titanium dioxide, Wollastonite, glass flakes, glass beads and fibers, and polymeric fibers and combinations thereof.

In one embodiment, the thermoformed films or sheets are multilayered films or sheets. In one embodiment at least one layer of the multilayer film or sheet is a foam or foamed polymer or polyester layer.

One aspect of the present disclosure is a method of making molded or shaped parts and articles using thermoforming. Any thermoforming techniques or processes known to those skilled in the art may be used to produce the molded or shaped articles of this disclosure.

In one embodiment, the thermoforming processes can be done in several ways, for example as taught in “Technology of Thermoforming”; Throne, James; Hanser Publishers; 1996; pp. 16-29, which is incorporated herein by reference. In some embodiments, it is a positive thermoforming process where gas or air pressure is applied to the softened sheet, the sheet is then stretched and drawn out like a bubble and a male mold is brought into the bubble from the inside. Then vacuum is applied to further draw and conform the part to the male mold surface. In this thermoforming process biaxial stretching/orientation is done primarily in one step when there is a gas or air pressure applied to the softened sheet. The molding step is then completed with the vacuum and male mold to freeze the orientation into the sheet for a good balance of physical and appearance properties. In other embodiments, it is a negative thermoforming process where a vacuum or a physical plug is applied to the heat softened sheet and stretches and draws the sheet to nearly the final part size, and then, positive air pressure from the inside or further external vacuum from the outside draws and conforms the sheet against an outer, female mold, the orientation is frozen into the polymer and the sheet is formed into the article.

In some embodiments, the produced bubble is sometimes further formed by making use of a plug assist, and this is followed by draping and shaping the sheet over the rising positive mold and then the corners and shelves guides, etc. are pulled into the mold by applying a vacuum. In some embodiments, after removal from the mold, the molded parts or articles can be trimmed, holes punched, and corners cut out as needed.

In other embodiments, thermoforming is a process where a film or sheet of the polyester compositions of the present disclosure are heated to a temperature sufficient to allow the deformation thereof, and the heated film or sheet is then made to conform to the contours of a mold by such means as vacuum assist, air pressure assist and matched mold assist. In another embodiment, the heated film or sheet is placed in a mold and forced to conform to the contours of the mold by, for example, application of air pressure, application of a vacuum, plug assist or application of a matching mold. In some embodiments, thermoforming produces thin wall articles.

In one embodiment, the thermoforming process molds the films or sheets into the desired shapes through the pressing of positive molds into the heated films or sheets. In this embodiment, thermoforming involves having a positive mold of an article supported between a vacuum-equipped surface or table. In this embodiment, heat from an external heat source such as a hot air blower, heat lamp or other radiant heat source is directed at the film or sheet. In this embodiment, the film or sheet is heated to the point of softening. In this embodiment, a vacuum is then applied to and below the table and around the mold, and the heat softened film or sheet is drawn toward the table, thus placing the softened film or sheet in contact with the mold surface. In this embodiment, the vacuum draws the softened film or sheet into tight contact with, and conformance to, the contours of the mold surface. As such, the film or sheet then assumes the shape of the mold. In this embodiment, after the film or sheet cools, it hardens, and the resulting article or part may be removed from the mold.

In one embodiment, the thermoforming process comprises: forming a film or sheet from the polyester compositions of the present disclosure; heating the film or sheet until it softens and positioning it over a mold; drawing the preheated film or sheet onto the heated mold surface; cooling the film or sheet; and then removing the molded article or part from the mold cavity, or optionally, heatsetting the formed film or sheet by maintaining the film or sheet in contact against the heated mold for a sufficient time period to partially crystallize the film or sheet.

In one embodiment, the thermoforming process comprising: forming a film or sheet from the polyester compositions of the present disclosure; heating a film or sheet to a temperature at or above the Tg of the polyester; applying gas, vacuum and/or physical pressure to the heat softened film or sheet and stretching the film or sheet to nearly the final part size; conforming the sheet by vacuum or pressure to a mold shape; cooling the film or sheet to a temperature below the Tg of the polyester; and then removing the thermoformed article or part from the mold.

The film and sheet used in the thermoforming process can be made by any conventional method known to those skilled in the art. In one embodiment, the sheet or film is formed by extrusion. In one embodiment, the sheet or film is formed by calendering. In one embodiment, during the thermoforming process the film or sheet is heated to a temperature at or above the Tg of the polyester. In one embodiment, this temperature is about 10 to about 60° C. above the Tg of the polyester. In one embodiment, the heating of the film or sheet prior to positioning over the thermoforming mold is necessary in order to achieve a shorter molding time. In one embodiment, the sheet must be heated above its Tg and below the point at which it sags excessively during positioning over the mold cavity. In one embodiment, before the molded film or sheet is removed from the mold it is allowed to cool to a temperature below the Tg of the polyester. In one embodiment, the thermoforming methods may include vacuum assist, air assist, mechanical plug assist or matched mold. In some embodiments, the mold is heated to a temperature at or above the Tg of the film or sheet. Selection of optimum mold temperature is dependent upon type of thermoforming equipment, configuration and wall thickness of article being molded and other factors.

In some embodiments, the heated film or sheet is stretched by creating and pulling a vacuum.

In one embodiment, heatsetting is the process of thermally inducing partial crystallization of a polyester film or sheet without appreciable orientation being present. In one embodiment, heatsetting is achieved by maintaining contact of the film or sheet with the heated mold surface for a sufficient time to achieve a level of crystallinity which gives adequate physical properties to the finished part. In one embodiment, the levels of crystallinity should be about 10 to about 30 percent.

In one embodiment, the heatset part can be removed from the mold cavity by known means for removal. For example, in one embodiment, blowback is used and it involves breaking the vacuum established between the mold and the formed film or sheet by the introduction of compressed air. In some embodiments, the molded article or part is subsequently trimmed and the scrap ground and recycled.

In some embodiments, the addition of nucleating agents provide faster crystallization during thermoforming and thus provide for faster molding. In one embodiment, nucleating agents such as fine particle size inorganic or organic materials may be used. For example, in one embodiment, suitable nucleating agents include talc, titanium dioxide, calcium carbonate, and immiscible or cross-linked polymers. In one embodiment, the nucleating agents are used in amounts varying from about 0.01% to about 20%, based on the weight of the article. In one embodiment, other conventional additives such as pigments, dyes, plasticizers, anti-cracking agent and stabilizers may be used as needed for thermoforming. In some embodiments, the anti-cracking agent improves impact strength, and the nucleating agent provides faster crystallization. In some embodiments, crystallization is necessary to achieve high temperature stability.

In one embodiment, a foamed polyester film or sheet is made by foaming a polyester composition of the present disclosure with chemical and/or physical blow agents, extruding the foamed polyester into sheet or film, and thermoforming the foamed polyester film or sheet. Additives for providing enhanced properties to the foamed polyester film may be added to the polyester prior to foaming. Some examples of additives include slip agents, antiblocking agents, plasticizers, optical brightener and ultra violet inhibitor. In one embodiment, the foamed polyester films can be extrusion or lamination coated on one side or on both sides using conventional techniques in order to enhance its properties. In one embodiment, the coating materials may be the printed surface, rather than the foam film itself, that provides for product labelling.

The compositions of this disclosure are useful as molded or shaped plastic parts or as solid plastic objects. The compositions of this disclosure are useful as thermoformed parts or articles. The compositions are suitable for use in any applications where clear, hard plastics are required. Examples of such parts include disposable knives, forks, spoons, plates, cups, straws as well as eyeglass frames, toothbrush handles, toys, automotive trim, tool handles, camera parts, parts of electronic devices, razor parts, ink pen barrels, disposable syringes, bottles, and the like. In one embodiment, the compositions of the present disclosure are useful as plastics, films, fibers, and sheets. In one embodiment the compositions are useful as plastics to make bottles, bottle caps, eyeglass frames, cutlery, disposable cutlery, cutlery handles, shelving, shelving dividers, electronics housing, electronic equipment cases, computer monitors, printers, keyboards, pipes, automotive parts, automotive interior parts, automotive trim, signs, thermoformed letters, siding, toys, thermally conductive plastics, ophthalmic lenses, tools, tool handles, and utensils. In another embodiment, the compositions of the present disclosure are suitable for use as films, sheeting, fibers, molded articles, shaped articles, molded parts, shaped parts, medical devices, dental trays, dental appliances, containers, food containers, shipping containers, packaging, bottles, bottle caps, eyeglass frames, cutlery, disposable cutlery, cutlery handles, shelving, shelving dividers, furniture components, electronics housing, electronic equipment cases, computer monitors, printers, keyboards, pipes, toothbrush handles, automotive parts, automotive interior parts, automotive trim, signs, outdoor signs, skylights, multiwall film, multilayer film, insulated parts, insulated articles, insulated containers, thermoformed letters, siding, toys, toy parts, trays, food trays, dental trays, thermally conductive plastics, ophthalmic lenses and frames, tools, tool handles, and utensils, healthcare supplies, commercial foodservice products, boxes, film for graphic arts applications, plastic film for plastic glass laminates, point of purchase displays, skylights, smoke vents, laminated cards, fenestration, glazing, partitions, ceiling tiles, lighting, machine guards, graphic arts, lenticular, extrusion laminated sheets or films, decorative laminates, office furniture, face shields, medical packaging, sign holders on point of display shelving, and shelf price holds.

The present thermoformed or thermoformable compositions are useful in forming films, molded articles, molded parts, shaped articles, shaped parts and sheeting. The methods of making the thermoformed or thermoformable compositions into films, molded articles, molded parts, shaped articles, shaped parts and sheeting can be according to any methods known in the art. Examples of molded articles include without limitation: medical devices, medical packaging, healthcare supplies, commercial foodservice products such as trays, containers, food pans, tumblers, storage boxes, bottles, food processors, blender and mixer bowls, utensils, water bottles, crisper trays, washing machine parts, refrigerator parts, vacuum cleaner parts, ophthalmic lenses and frames, and toys.

One embodiment of the present disclosure is a method of making the thermoformed film or sheet comprising: A. heating the polyester film or sheet; B. applying air pressure, vacuum and/or physical pressure to the heat softened film or sheet; C. conforming the sheet by vacuum or pressure to a mold shape; and D. removing the thermoformed part or article from the mold.

This disclosure further relates to articles of manufacture comprising the film(s) and/or sheet(s) containing polyester compositions described herein. In embodiments, the films and/or sheets of the present disclosure can be of any thickness as required for the intended application.

This disclosure further relates to the film(s) and/or sheet(s) described herein. The methods of forming the polyester compositions into film(s) and/or sheet(s) includes any methods known in the art. Examples of film(s) and/or sheet(s) of the disclosure including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendaring, compression molding, wet block processing, dry block processing and solution casting.

This disclosure further relates to the molded or shaped articles described herein. The methods of forming the polyester compositions into molded or shaped articles includes any known methods in the art. Examples of molded or shaped articles of this disclosure including but not limited to thermoformed or thermoformable articles, injection molded articles, extrusion molded articles, injection blow molded articles, injection stretch blow molded articles and extrusion blow molded articles. Methods of making molded articles include but are not limited to thermoforming, injection molding, extrusion, injection blow molding, injection stretch blow molding, and extrusion blow molding. The processes of this disclosure can include any thermoforming processes known in the art. The processes of this disclosure can include any blow molding processes known in the art including, but not limited to, extrusion blow molding, extrusion stretch blow molding, injection blow molding, and injection stretch blow molding.

This disclosure includes any injection blow molding manufacturing process known in the art. Although not limited thereto, a typical description of injection blow molding (IBM) manufacturing process involves: 1) melting the composition in a reciprocating screw extruder; 2) injecting the molten composition into an injection mold to form a partially cooled tube closed at one end (i.e. a preform); 3) moving the preform into a blow mold having the desired finished shape around the preform and closing the blow mold around the preform; 4) blowing air into the preform, causing the preform to stretch and expand to fill the mold; 5) cooling the molded article; 6) ejecting the article from the mold.

This disclosure includes any injection stretch blow molding manufacturing process known in the art. Although not limited thereto, a typical description of injection stretch blow molding (ISBM) manufacturing process involves: 1) melting the composition in a reciprocating screw extruder; 2) injecting the molten composition into an injection mold to form a partially cooled tube closed at one end (i.e. a preform); 3) moving the preform into a blow mold having the desired finished shape around the preform and closing the blow mold around the preform; 4) stretching the preform using an interior stretch rod, and blowing air into the preform causing the preform to stretch and expand to fill the mold; 5) cooling the molded article; 6) ejecting the article from the mold.

This disclosure includes any extrusion blow molding manufacturing process known in the art. Although not limited thereto, a typical description of extrusion blow molding manufacturing process involves: 1) melting the composition in an extruder; 2) extruding the molten composition through a die to form a tube of molten polymer (i.e. a parison); 3) clamping a mold having the desired finished shape around the parison; 4) blowing air into the parison, causing the extrudate to stretch and expand to fill the mold; 5) cooling the molded article; 6) ejecting the article of the mold; and 7) removing excess plastic (commonly referred to as flash) from the article.

The following examples further illustrate how the polyesters of the present disclosure can be made and evaluated, they and are intended to be purely exemplary and are not intended to limit the scope thereof. Unless indicated otherwise, parts are parts by weight, temperature is in degrees C. (Celsius) or is at room temperature, and pressure is at or near atmospheric.

The following examples further illustrate how the polyesters of the present disclosure can be made and evaluated, they and are intended to be purely exemplary and are not intended to limit the scope thereof. Unless indicated otherwise, parts are parts by weight, temperature is in degrees C. (Celsius) or is at room temperature, and pressure is at or near atmospheric.

### EXAMPLES

This disclosure can be further illustrated by the following examples of embodiments thereof, although it will be understood that these examples are included merely for purposes of illustration and are not intended to limit the scope of the disclosure unless otherwise specifically indicated.

### General Multilayer Film Making Process and Property Test Description

The multilayer heat-shrinkable polyester films in the Examples were prepared and evaluated by a method comprising the steps of:
(a) melting and extruding the random copolymer resin with certain layer structure to obtain an unstretched A|B|A trilayer film;
(b) stretching the unstretched multilayer film in the one direction;
(c) evaluating various film properties (including glass transition temperature (Tg), strain-induced melting point (Tm), shrinkage as a function of temperature (shrink curve), tensile test and shrink force (SF)) and
(d) evaluating film recyclability through clump testing.

### Multilayer Structure/Composition Ranges

The multilayer film comprising three layers—ABA structure—as shown in Scheme 1.

The first and second skin layer (layer A) containing a blend of an amorphous copolyester resin 1 and a crystallizable resin 2.

The weight ratio (wt %) of resin 1 and resin 2 ranges from 0/100 to 30/70.

The compositions of copolyesters blend in layer A comprising residues of:
(A) A diacid component containing at least 70 mol % terephthalic acid residues
(B) A diol component containing
   (i) about 50 to about 90 mol % EG residues
   (ii) about 1-35 mol % CHDM residues,
   (iii) 0-30 mol % NPG residues and
   (iv) 0.1-15 mol % DEG residues
      with the final polymer containing substantially equal molar proportions of acid equivalents (100 mole %) and diol equivalents (100 mole %) for a total of 200 mole % for all reactants.

The core layer (layer B) arranged between the first and second skin layer comprised of a blend of an amorphous copolyester resin 1 and a crystallizable copolyester resin 3.

The weight ratio for resin 1 and resin 3 in the core layer by weight ranges from 80/20-40/60.

The compositions of copolyesters blend in the layer B comprising residues of:
(C) A diacid component containing at least 70 mol % terephthalic acid residues
(D) A diol component containing
   (i) about 50 to about 95 mol % EG residues
   (ii) 0-25 mol % CHDM residues, more preferred 5-15 mol % and
   (iii) 0.1-15 mol % DEG residues, more preferred 5-12 mol %
      with the final polymer containing substantially equal molar proportions of acid equivalents (100 mole %) and diol equivalents (100 mole %) for a total of 200 mole % for all reactants.

TABLE 1
Resin used in the multilayer film

| | | | | | | | Glass | Crystallization |
|---|---|---|---|---|---|---|---|---|
| | Acids | | Glycols | | | | transition | melting |
| | TPA | IPA | EG | CHDM | NPG | DEG | temperature | temperature |
| | (mol %) | (mol %) | (mol %) | (mol %) | (mol %) | (mol %) | (Tg, ° C.) | (Tm, ° C.) |
| Resin 1 | 100 | — | 65 | 23 | | 12 | 70 | NA |
| Resin 2 | 100 | — | 82 | 4.5 | 9.5 | 3.9 | 75 | 210 |
| Resin 3- | 97.8 | 2.2 | 97.42 | | | 2.58 | 78 | 246 |
| rPET | | | | | | | | |

TABLE 2
Multilayer structures

| | | Comparative | | Comparative | | | | | |
|---|---|---|---|---|---|---|---|---|---|
| | | Example 1 | | Example 2 | | Example 1 | | Example 2 | |
| | | Skin | Core | Skin | Core | Skin | Core | Skin | Core |
| | | layer A | layer B | layer A | layer B | layer A | layer B | layer A | layer B |
| A\|B\|A layer | Resin 1 | 100 | 100 | 0 | 0 | 20 | 90 | 20 | 70 |
| composition | Resin 2 | 0 | 0 | 100 | 100 | 80 | 10 | 80 | 30 |
| (wt %) | Resin 3 | 0 | 0 | 0 | 0 | 0 | 0 | 0 | 0 |
| | | Example 3 | | Example 4 | | Example 5 | | Example 6 | |
| | | Skin | Core | Skin | Core | Skin | Core | Skin | Core |
| | | layer A | layer B | layer A | layer B | layer A | layer B | layer A | layer B |
| A\|B\|A layer | Resin 1 | 20 | 70 | 20 | 60 | 20 | 50 | 100 | 50 |
| composition | Resin 2 | 80 | 0 | 80 | 0 | 80 | 0 | 0 | 0 |
| (wt %) | Resin 3 | 0 | 30 | 0 | 40 | 0 | 50 | 0 | 50 |

### Film Property Ranges

For thermal properties in each layer, the first and second skin layers (layer A) comprised of at least 50 wt % of a crystallizable resin 2 with Tm≥190° C., more preferred Tm≥200° C. measured from the second scan of Differential Scanning calorimetry (DSC) at a scan rate of 20° C./min. The third layer (layer B) arranged between the first and second layer is preferred to have an amorphous copolyester resin 1 no more than 95 wt %, more preferred is to have no more than 80 wt % with Tg≤78° C. measured from DSC.

The third layer (layer B) arranged between the first and second layer has rPET (resin 3) ranges from 0.1-90 wt % rPET, with preferred ranges from 10 wt %-70 wt %; more preferred ranges from 20 wt %-60 wt %.

For the film thickness in each layer, if measured, the first and second skin layer (layer A) is preferred to have a thickness ranges from 1-4 mil and the third layer (layer B) is preferred to have a thickness ranges from 2-8 mil prior to stretching.

The desired performance for shrink film made with this multilayer structure includes (a) The ultimate shrinkage in the main shrinkage direction (transverse direction, TD) of at least have 50%, preferred 70% or greater, which increases gradually with increasing temperature; (b) The shrinkage in the direction orthogonal to the main shrinkage direction at 80° C. should be negative (i.e., growth) or no shrinkage; (c) The final shrinkage films should also possess a shrink force less than 10 MPa measure at 80° C.; (d) A break strain percentage of greater than 100% at a stretching speed of 300 mm/min in machine direction (MD, direction orthogonal to the main shrinkage direction)

Film recyclability. Shrunk film heated together with rPET flake with 3 wt % of shrunk film at 208° C. for 90 mins showing <5% clumping, more preferred <1% clumping measured by clump test described in experimental section.

Film preferably has an inherent viscosity (I.V.) of 0.5-0.9 dL/g, more preferred of 0.55-0.7 dL/g for good film physical property and film processability.

### Film Fabrication Process

A process for preparing the multilayer film, comprising drying the polymer pellets at 135 F for 4-6 hours, melt-extrude at 220° C.-300° C., more preferred from 240° C.-260° C. through 1″ Killion extruder in B230 to obtain an unstretched film. Stretching the unstretched film using the Bruckner Karo machine in one direction at 70° C.-100° C. by about 3-6 times the original dimensions, more preferred from stretch at 70° C.-90° C. by about 3-5 times. The thickness of the heat-shrinkable polyester film prepared in accordance with the present invention may be 20 μm to 80 μm, preferably 30 μm to 50 μm. The stretched film was evaluated for various film properties, including glass transition temperature (Tg), strain-induced melting point (Tm), shrinkage as a function of temperature (shrink curve), tensile test and shrink force (SF)) and (e) evaluating film recyclability through clump testing.

### Analytical Test

Inherent viscosity (I.V.)—IV was measured in a 60/40 parts by weight solution of phenol/tetrachloroethane at 250° C. and at a concentration of about 0.5 g of polymer in 100 mL of said solvent.

Film glass transition temperature (Tg) and melting temperature (Tm) All thermal tests for these pellets and stretched film were completed at standard differential scanning calorimetry (DSC) scans at a scan rate of 20° C./min.

Shrink force (SF)—Shrink force was determined using a Labthink FST-02 shrink force tester. Shrink force measurements were conducted under the same temperature conditions as the stretching temperatures used to stretch films on the Bruckner (80° C.) and held in the heating chamber for 60 seconds—to ascertain the maximum shrink force value of each film.

Shrinkage-Shrinkage was measured by placing a 50 mm by 50 mm square film sample in water at temperatures ranging from 60° C. to 95° C. for 10 seconds without restricting shrinkage in any direction. The percent shrinkage was then calculated using the following equation:

$$\% shrinkage = [ ( 50 mm - length after shrinkage ) / 50 mm ] \times 100 \%$$

Shrinkage was measured in the direction orthogonal to the main shrinkage direction (machine direction, MD) and was also measured in the main shrinkage direction (transverse direction, TD).
Negative shrinkage indicated growth

Tensile property—The film was tested for MD break strain using ASTM Method D882. The film was prepared by cutting them to 3.5″×0.5″ strips and tested at a stretching speed of 300 mm/min.

PET Clumping—A clump test of these compositions was performed by first shrinking the stretched films at 85° C. for 10 seconds and shredding the shrunken material to create shrink flake. 18 grams of shrink flake was then combined with 582 grams of PET flake and spread evenly into an aluminum cooking pan, ensuring a depth of 1.5″ of material. The pan was placed in a forced air oven set to 208° C. for 90 minutes and allowed to cool before being evaluated for clumping percentage using the formula below.

$$[ ( Weight of remaining material + pan ) - ( weight of pan ) / ( 600 g ) ] \times 100 = degree of clumping ( \% )$$

### Comparative Examples

NOTE: Comments for shrink film performance in tables below

GOOD: The desired performance for shrink film made with this multilayer structure includes.
The ultimate shrinkage in the main shrinkage direction (transverse direction, TD) of at least has 50%, preferred 70% or greater, which increases gradually with increasing temperature.
The shrinkage in the main shrinkage direction at 70° C. at least has 5%.
The shrinkage in the direction orthogonal to the main shrinkage direction at 80° C. should be negative (i.e., growth) or no shrinkage;
The final shrinkage films should also possess a shrink force less than 10 MPa measure at 80° C.;
A break strain percentage of greater than 100% at a stretching speed of 300 mm/min in machine direction (MD, direction orthogonal to the main shrinkage direction).

The shrunk film dried together with PET flake at oven at 208° C. for 90 mins shown <1% clumping.

NOT IDEAL: Shrink film performance didn't meet the criteria described for “good”

### Comparative Examples

The composition and film properties of comparative examples are shown in the table 3 below.

TABLE 3

| | | Comparative | | Comparative | | |
|---|---|---|---|---|---|---|
| | | Example 1 | | Example 2 | | |
| | | Skin | Core | Skin | Core | |
| Film description | | layer A | layer B | layer A | layer B | |
| A\|B\|A layer | Resin 1 | 100 | 100 | — | — | |
| composition | Resin 2 | — | — | 100 | 100 | |
| (wt %) | Resin 3 | — | — | — | — | |
| A layer\|B layer A layer | | NA | | NA | | |
| thickness (mm) | | | | | | |
| IV, Inherent viscosity (dL/g) | | 0.7 | | 0.64 | | |
| Tg, Glass transition | | 69 | | 74 | | |
| temp. (° C.) | | | | | | |
| Strain-induced Tm (° C.) | | 159 | | 210 | | |
| Composition | TPA (mol %) | 100 | | 100 | | |
| | EG (mol %) | 64.14 | | 82.12 | | |
| | TEG (mol %) | — | | — | | |
| | NPG (mol %) | — | | 9.49 | | |
| | CHDM | 22.88 | | 4.45 | | |
| | (mol %) | | | | | |
| | DEG (mol %) | 11.35 | | 3.92 | | |
| | | Temp. | | | | |
| | Target | (° C.) | MD | TD | MD | TD |
| Heat | | 60.00 | 0.0 | 1.0 | 0.0 | 1.0 |
| shrinkage | | 65.00 | 2.0 | 5.0 | 1.0 | 2.0 |
| (%) | TD ≥ 5% | 70.00 | 1.0 | 26.0 | 2.0 | 4.0 |
| | | 75.00 | −8.0 | 48.0 | 4.0 | 16.0 |
| | MD ≤ 0 | 80.00 | −12.0 | 64.0 | 0.0 | 36.0 |
| | | 85.00 | −8.0 | 74.0 | 0.0 | 48.0 |
| | | 90.00 | −10.0 | 76.0 | 0.0 | 54.0 |
| | TD ≥ 50% | 95.00 | −5.0 | 78.0 | −3.0 | 58.0 |

| | | | | |
|---|---|---|---|---|
| MD break | >100% | R.T. | 459 | 361 |
| strain | | | | |
| (%, at 300 | | | | |
| mm/min) | | | | |
| Shrink force | ≤10 | 80 | 6.1 | 8.3 |
| (MPa) | | | | |
| PET | <1 | 208 | 11 | 0.7 |
| clumping | | | | |
| (%) | | | | |

| | | |
|---|---|---|
| Comment | Not Ideal | Not ideal |

TABLE 4
Examples 1-2: Resin 1/Resin 2 blend| Resin 1/Resin 2 blend| Resin
1/Resin 2 blend

| | | | Example 1 | | Example 2 | |
|---|---|---|---|---|---|---|
| | | | Skin | Core | Skin | Core |
| Film description | | | layer A | layer B | layer A | layer B |
| A\|B\|A layer | Resin 1 | | 20 | 90 | 20 | 70 |
| composition | Resin 2 | | 80 | 10 | 80 | 30 |
| (wt %) | Resin 3 | | — | — | — | — |
| A layer\|B layer\|A layer | | | 39\|121\|46 | | 54\|139\|56 | |
| thickness (μm) | | | | | | |
| IV, Inherent viscosity (dL/g) | | | 0.68 | | 0.68 | |
| Tg, Glass transition temp. (° C.) | | | 71 | | 72 | |
| Strain-induced Tm (° C.) | | | 208 | | 204 | |
| Composition | TPA (mol %) | | 100 | | 100 | |
| | EG (mol %) | | 74 | | 75.48 | |
| | TEG (mol %) | | — | | — | |
| | NPG (mol %) | | 5.2 | | 5.87 | |
| | CHDM (mol %) | | 13.2 | | 11.74 | |
| | DEG (mol %) | | 7.6 | | 6.91 | |
| | | Temp. | | | | |
| | Target | (° C.) | MD | TD | MD | TD |
| Heat | | 60.00 | 0.0 | 0.0 | 0.0 | 0.0 |
| shrinkage | | 65.00 | 1.0 | 4.0 | 0.0 | 1.0 |
| (%) | TD ≥ 5% | 70.00 | 2.0 | 10.0 | 2.0 | 6.0 |
| | | 75.00 | 2.0 | 28.0 | 4.0 | 26.0 |
| | MD ≤ 0 | 80.00 | −4.0 | 48.0 | −2.0 | 46.0 |
| | | 85.00 | −6.0 | 64.0 | −4.0 | 62.0 |
| | | 90.00 | −4.0 | 67.0 | −4.0 | 64.0 |
| | TD ≥ 50% | 95.00 | −2.0 | 72.0 | −2.0 | 73.0 |

| | | | | |
|---|---|---|---|---|
| MD break | >100% | R.T. | 370 | 336 |
| strain | | | | |
| (%, at 300 | | | | |
| mm/min) | | | | |
| Shrink force | ≤10 | 80 | 6.8 | 7.8 |
| (MPa) | | | | |
| PET | <1 | 208 | 15 | 10 |
| clumping (%) | | | | |

| | | |
|---|---|---|
| Comment | Not Ideal | Not ideal |

TABLE 5
Examples 3-6: Resin 1/Resin 2 blend|Resin1/rPET blend |Resin1/Resin 2 blend

| | | Example 3 | | Example 4 | | Example 5 | | Example 6 | | |
|---|---|---|---|---|---|---|---|---|---|---|
| | | Skin | Core | Skin | Core | Skin | Core | Skin | Core | |
| | | layer A | layer B | layer A | layer B | layer A | layer B | layer A | layer B | |
| A\|B\|A layer | Resin 1 | 20 | 70 | 20 | 60 | 20 | 50 | 100 | 50 | |
| composition | Resin 2 | 80 | — | 80 | — | 80 | — | — | — | |
| (wt %) | Resin 3 | — | 30 | — | 40 | — | 50 | — | 50 | |
| A layer\|B layer\|A layer | | 64\| 130\|55 | | — | | — | | 60\|142\|54 | | |
| thickness (μm) | | | | | | | | | | |
| IV, Inherent viscosity (dL/g) | | 0.69 | | 0.69 | | 0.68 | | 0.70 | | |
| Tg, Glass transition temp. | | 72 | | 73 | | 73 | | 69 | | |
| (° C.) | | | | | | | | | | |
| Strain-induced Tm (° C.) | | 209 | | 209 | | 243 | | 243 | | |
| Composition | TPA (mol %) | 100 | | 100 | | 100 | | 100 | | |
| | EG (mol %) | 76.57 | | 78.1 | | 79.35 | | 70.68 | | |
| | TEG (mol %) | 0.76 | | 0.65 | | 0.63 | | 1.25 | | |
| | NPG (mol %) | 4.64 | | 4.9 | | 4.73 | | — | | |
| | CHDM (mol %) | 11.29 | | 10.12 | | 9.32 | | 17.93 | | |
| | DEG (mol %) | 6.74 | | 6.24 | | 5.96 | | 10.14 | | |
| | | Temp. | | | | | | | | |
| | Target | (° C.) | MD | TD | MD | TD | MD | TD | MD | TD |
| Heat | | 60.00 | 0.0 | 0.0 | 0.0 | 0.0 | 0.0 | 0.0 | 0.0 | 1.0 |
| shrinkage | | 65.00 | 0.0 | 1.0 | 0.0 | 2.0 | 2.0 | 2.0 | 2.0 | 4.0 |
| (%) | TD ≥ 5% | 70.00 | 6.0 | 8.0 | 2.0 | 6.0 | 2.0 | 6.0 | 4.0 | 22.0 |
| | | 75.00 | 2.0 | 30.0 | 4.0 | 20.0 | 3.0 | 16.0 | 0.0 | 40.0 |
| | MD ≤ 0 | 80.00 | −2.0 | 50.0 | 0.0 | 42.0 | 0.0 | 42.0 | −6.0 | 58.0 |
| | | 85.00 | −4.0 | 60.0 | −3.0 | 56.0 | −2.0 | 52.0 | −4.0 | 64.0 |
| | | 90.00 | −6.0 | 64.0 | 0.0 | 60.0 | −1.0 | 52.0 | −4.0 | 68.0 |
| | TD ≥ 50% | 95.00 | 0.0 | 68.0 | −2.0 | 66.0 | 0.0 | 58.0 | −2.0 | 72.0 |

| | | | | | | |
|---|---|---|---|---|---|---|
| MD break | >100% | R.T. | 380 | 465 | 470 | 345 |
| strain (%, at | | | | | | |
| 300 | | | | | | |
| mm/min) | | | | | | |
| Shrink force | ≤7.5 | 80 | 6.3 | 7.5 | 7.5 | 5.8 |
| (MPa) | | | | | | |
| PET | <1 | 208 | 0.42 | 0.46 | 0.73 | 12 |
| clumping | | | | | | |
| (%) | | | | | | |

| | | | | |
|---|---|---|---|---|
| Comment | Good | Good | Good | Not Ideal |

The present disclosure has been described in detail with particular reference to preferred embodiments thereof, but it will be understood that variations and modifications can be effected within the spirit and scope of this disclosure.

1. A multilayer crystallizable film comprising at least one skin layer (A) which comprises a polyester composition comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and at least one core layer (B) which comprises a blend of 30-100 wt % of at least one polyester composition comprising:
at least one polyester which comprises:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
(i) 15 mole % to less than about 30 mole % of 1,4-cyclohexanedimethanol residues;
(ii) about 7 mole % to less than about 15 mole % of total diethylene glycol residues or butanediol residues in the final polyester composition;
wherein the total mole % of the dicarboxylic acid component is 100 mole %, and
wherein the total mole % of the diol component is 100 mole %;
and 0-70 wt % at least one at least one polyester composition comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 50 mole % or greater of ethylene glycol residues and
about 50 mole % or less of other glycols comprising one or more of:
(i) 0 mole % to less than about 50 mole % of 1,4-cyclohexanedimethanol residues;
(ii) about 0.1 mole % to less than about 15 mole % of total diethylene glycol residues or butanediol residues in the final polyester composition;
wherein the total mole % of the dicarboxylic acid component is 100 mole %, and wherein the total mole % of the diol component is 100 mole %.

2. A multilayer crystallizable film comprising at least one skin layer (A) which comprises a blend of 50-99.9 wt % at least one polyester composition (1) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and
0.1-50 wt % of at least one polyester composition (2) comprising:
at least one polyester which comprises:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and
wherein the total mole % of the diol component is 100 mole %; and
at least one core layer (B) which comprises a blend of 30-95 wt % of at least one polyester composition (1) comprising:
at least one polyester which comprises:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and
5-70 wt % at least one at least one polyester composition (2) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 50 mole % or greater of ethylene glycol residues and about 50 mole % or less of other glycols comprising one or more of:
(i) 0 mole % to less than about 50 mole % of 1,4-cyclohexanedimethanol residues;
(ii) about 0.1 mole % to less than about 15 mole % of total diethylene glycol residues or butanediol residues in the final polyester composition;
wherein the total mole % of the dicarboxylic acid component is 100 mole %, and wherein the total mole % of the diol component is 100 mole %.

3. A multilayer crystallizable film comprising at least one skin layer (A) which comprises a blend of 50-99.9 wt % at least one polyester composition (1) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and
0.1-50 wt % of at least one polyester composition (2) comprising:
at least one polyester which comprises:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and
at least one core layer (B) which comprises a blend of 20-30 wt % of at least one polyester composition (1) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and 40-60 wt % of at least one polyester composition (2) comprising:
at least one polyester which comprises:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and
20-30 wt % at least one at least one polyester composition (3) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic (ii) dicarboxylic acid residues having up to 20 carbon atoms; and
(b) a diol component comprising:
about 50 mole % or greater of ethylene glycol residues and
about 50 mole % or less of other glycols comprising one or more of:
(i) 0 mole % to less than about 50 mole % of 1,4-cyclohexanedimethanol residues;
(ii) about 0.1 mole % to less than about 15 mole % of total diethylene glycol residues or butanediol residues in the final polyester composition;
wherein the total mole % of the dicarboxylic acid component is 100 mole %, and wherein the total mole % of the diol component is 100 mole %.

4. A multilayer crystallizable film comprising at least one skin layer (A) which comprises a blend of 50-70 wt % at least one polyester composition (1) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and
30-50 wt % of at least one polyester composition (2) comprising:
at least one polyester which comprises:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and
at least one core layer (B) which comprises a blend of 30-50 wt % of at least one polyester composition (1) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and
50-70 wt % at least one at least one polyester composition (2) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 50 mole % or greater of ethylene glycol residues and
about 50 mole % or less of other glycols comprising one or more of:
(i) 0 mole % to less than about 50 mole % of 1,4-cyclohexanedimethanol residues;
(ii) about 0.1 mole % to less than about 15 mole % of total diethylene glycol residues or butanediol residues in the final polyester composition;
wherein the total mole % of the dicarboxylic acid component is 100 mole %, and wherein the total mole % of the diol component is 100 mole %.

5. The multilayer crystallizable film of claim 1, wherein the polyester composition comprises:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 80 mole % or greater of ethylene glycol residues and
about 20 mole % or less of other glycols comprising one or more of:
(i) about 5 to less than about 17 mole % of neopentyl glycol residues;
(ii) about 2 to less than about 10 mole % of 1,4-cyclohexanedimethanol residues;
(iii) about 1 to less than about 10 mole % of total diethylene glycol residues or butanediol residues in the final polyester composition;
wherein the total mole % of the dicarboxylic acid component is 100 mole %, and wherein the total mole % of the diol component is 100 mole %.

6. The multilayer crystallizable film of claim 1, wherein said film has an A-B-A configuration.

7. The multilayer crystallizable film of claim 1, wherein the film is a heat shrinkable film; or wherein said film is stretched in at least one direction; or wherein said film is oriented in one or more directions; or wherein said film is stretched and oriented in at least one direction; or wherein said film is annealed; or wherein said film is annealed at a temperature from about 75° C. to about 110° C.

8. The multilayer crystallizable film of claim 1, wherein said film has a crystalline melting point of 190° C. to 225° C., or of 190° C. to 245° C., or of 150° C. to 245° C.; or wherein said film is stretched in at least one direction and the stretched film has a strain induced crystalline melting point of 200° C. or greater; or of 195° C. or greater; or of 180° C. or greater; or 150° C. or greater.

9. The multilayer crystallizable film of claim 1, wherein said film has shrinkage in the main shrinkage direction of from 60% or greater when immersed in water at 85° C. for 10 seconds; or wherein said film has shrinkage in the main shrinkage direction of from 50% or greater when immersed in water at 85° C. for 10 seconds; or wherein the film has a shrinkage in the main shrinkage direction in the amount of 50 to 90% and shrinkage in the direction orthogonal to the main shrinkage direction of 10% or less when immersed in water at 95° C. for 10 seconds.

10. The multilayer crystallizable film of claim 1, wherein said film has a shrink force of 5 MPa or greater; or wherein the film has a shrink force of less than 10 MPa; or wherein the film has a break strain percentage of greater than 100%.

11. The multilayer crystallizable film of claim 1, further comprising at least one voiding agent.

12. A lidding film, extrusion blow molded container, extruded sheet, thermoformed sheet, flexible packaging film for stand-up pouches comprising the multilayer crystallizable film of claim 1.

13. An article of manufacture, a shaped article, a container, a plastic bottle, a glass bottle, packaging, a battery, a hot fill container, or an industrial article having a label or sleeve applied thereto, said label or sleeve comprising the multilayer crystallizable film of claim 1.

14. The multilayer crystallizable film of claim 1, wherein said film is used in applications chosen from a medical device packaging, medical packaging, pharmaceutical supplies, pharmaceutical packaging, blister packs, healthcare supplies packaging, commercial foodservice products, trays, containers, food pans, tumblers, storage boxes, bottles, food processors, blender and mixer bowls, utensils, water bottles, crisper trays, washing machine parts, refrigerator parts, vacuum cleaner parts, ophthalmic lenses and frames or toys.

15. The multilayer crystallizable film of claim 1, wherein the film is recyclable in a PET recycle stream.

16. A polyester recycle stream comprising recycled poly(ethylene terephthalate) flake, having admixed therewith at least about 0.1 weight percent of recycled multilayer crystallizable film of claim 1.

17. The polyester recycle stream of claim 16, comprising recycled poly(ethylene terephthalate) flake, having admixed therewith at least about 0.1 weight percent of multilayer crystallizable recycled shrink film, wherein said stream passes the “Critical Guidance Protocol for Clear PET Articles with Labels and Closures”, dated Apr. 11, 2019, Document No. PET-CG-02.

18. The multilayer crystallizable film of claim 1, further comprising at least one polyester composition with recycle content; or wherein the polyester composition comprises recycled PET; or wherein said EG of the polyester compositions recycled EG (rEG); or wherein said CHDM of the polyester compositions is recycled CHDM (rCHDM) or the CHDM is produced from recycled DMT (rDMT); or wherein at least a portion of the dicarboxylic acid residues and/or glycol residues are derived from (i) recycled monomeric species chosen from rDMT, rTPA, rDMI, rEG, rDEG, and rCHDM and (ii) rPET.

19. The multilayer crystallizable film of claim 1, wherein the Inherent viscosity of the film is from 0.50 to 0.80 dL/g as determined in 60/40 (wt/wt) phenol/tetrachloroethane at a concentration of 0.5 g/dl at 25° C., and/or wherein the film has a Tg of from 65° C. to 80° C. as determined using a TA DSC 2920 from Thermal Analyst Instrument at a scan rate of 20° C./min.

20. The multilayer crystallizable film of claim 1, wherein the film has less than 1% PET clumping measured in accordance with the “Critical Guidance Protocol for Clear PET Articles with Labels and Closures”, dated Apr. 11, 2019, Document No. PET-CG-02.
